(19) United States
(12) Patent Application Publication
(10) Pub. No.: US 2017/0031452 A1
(43) Pub. Date: Feb. 2, 2017

(54) MANIPULATION DETERMINATION APPARATUS, MANIPULATION DETERMINATION METHOD, AND, PROGRAM

(71) Applicant: JUICE DESIGN CO., LTD., Tatsuno-city (JP)

(72) Inventor: Taro ISAYAMA, Tatsuno-city (JP)

(73) Assignee: JUICE DESIGN CO., LTD., Tatsuno-city (JP)

(21) Appl. No.: 15/112,094

(22) PCT Filed: Jan. 15, 2015
(86) PCT No.: PCT/JP2015/050950

§ 371 Date: Oct. 14, 2016

(30) Foreign Application Priority Data
Jan. 15, 2014 (JP) 2014-004827

(51) Int. Cl. G06F 3/01; G06F 3/0482; G06F 3/0484; G06K 9/00

(52) U.S. Cl. CPC G06F 3/017; G06F 3/012; G06F 3/013; G06K 9/00369; G06K 9/00315; G06F 3/0482; G06F 3/04847

(57) ABSTRACT

A manipulation determination apparatus, a manipulation determination method, and a program, which are capable of improving manipulability in performing a manipulation by moving a body. A state of the living body of a user is recognized, and a position or area is allocated on a computer space so as to move in conjunction with the recognized state of the living body. A manipulation corresponding to a motion of the living body is determined based on required conditions that a whole or part of the position or area passes through a boundary plane or boundary line on the computer space, and that parts of the living body perform a contact action or a non-contact action.

### TECHNICAL FIELD

The present invention relates to a manipulation determination apparatus, a manipulation determination method, and, a program.

### BACKGROUND ART

Heretofore, there has been developed a method of manipulating a computer according to a motion of the body of a user.

For example, a method for KINECT for WINDOWS (Registered Trademark) produced by Microsoft Corporation has been developed with SDK (Software Developer's Kit), the method enabling a user to move a cursor on a screen plane by moving his/her hand held in the air up or down and from side to side, and to perform a click manipulation at the cursor position by performing an action of pushing out the hand toward the screen.

In addition, an input device described in Patent Document 1 is disclosed as follows. Specifically, in order for a person to input information byway of a hand or finger action without touching an apparatus, the input device captures images of a hand or finger of the input person pointed to a display, and calculates a direction in which the hand or finger is pointed over the display on the basis of the captured images. Then, the input device displays a cursor on the display to present a position on the display corresponding to the calculated direction. When detecting a click action of the hand or finger, the input device selects, as information submitted by the input person, information in a portion where the cursor is positioned.

### CONVENTIONAL TECHNIQUE DOCUMENT

### Patent Document

Patent Document 1: JP-A-5-324181

### SUMMARY OF THE INVENTION

### Problem to be Solved by the Invention

However, the conventional manipulation method without touching the apparatus has a problem in that a user tends to easily perform an unintended manipulation while conducting a usual body activity. Meanwhile, as for recently-developed terminals, a watch-type wearable terminal or the like is equipped with only a small display or even no display, whereas a glasses-type wearable terminal, a head-up display or the like is even equipped with a display device but is temporality operated with the display hidden. In the case of using such terminals, a user tends to more easily perform a wrong action, in particular, because the user can hardly see a visual feedback corresponding to the motion of his/her own body.

The present invention has been made in view of the foregoing problem, and has an objective to provide a manipulation determination apparatus, a manipulation determination method, and a program, which are capable of improving manipulability in performing a manipulation by moving a body.

According to one aspect of the present invention, a manipulation determination apparatus includes a living body recognition unit that recognizes a state of a living body of a user, an allocation unit that allocates a first area onto a computer space such that the first area moves in conjunction with the recognized state of the living body, a change unit that changes a motion of the first area in conjunction with the living body so as to make it harder for the first area to move through a second area allocated on the computer space, and a manipulation determination unit that determines that a manipulation corresponding to the second area is done when the first area and the second area come to have a predetermined relation.

According to another aspect of the present invention, a manipulation determination apparatus includes a living body recognition unit that recognizes a state of a living body of a user, an allocation unit that allocates a first area onto a computer space such that the first area moves in conjunction with the recognized state of the living body, a change unit that moves a second area allocated on the computer space such that the second area keeps away from the coming first area, and a manipulation determination unit that determines that a manipulation corresponding to the second area is done when the first area and the second area come to have a predetermined relation.

According to another aspect of the present invention, a manipulation determination apparatus includes a living body recognition unit that recognizes a state of a living body of a user, an allocation unit that allocates a position or area onto a computer space such that the position or area moves in conjunction with the recognized state of the living body, and a manipulation determination unit that, when determining a manipulation corresponding to a motion of the living body, uses required conditions that a whole or part of the position or area passes through a boundary plane or boundary line on the computer space, and that parts of the living body perform a contact action or a non-contact action.

In the manipulation determination apparatus according to still another aspect of the present invention, the living body is at least any one of the head, mouth, feet, legs, arms, hands, fingers, eyelids and eyeballs of the user.

In the manipulation determination apparatus according to still another aspect of the present invention, the contact action by the parts of the living body is any one of an action of bringing at least two fingertips or finger pads into contact with each other, an action of joining and touching at least two fingers together, an action of closing a flat open hand, an action of laying down a thumb in a standing state, an action of bringing a hand or finger into contact with a part of the body, an action of bringing both hands or both feet into contact with each other, an action of closing the opened mouth, and an action of closing an eyelid.

In the manipulation determination apparatus according to still another aspect of the present invention, the non-contact action by the parts of the living body is any one of an action in which at least two fingertips or finger pads in contact with each other are moved away from each other, an action in which two fingers whose lateral sides are in contact with each other are moved away from each other, an action of opening a closed hand, an action of raising up a thumb in a lying state, an action in which a hand or finger in contact with a part of the body is moved away from the part, an action in which both hands or both legs in contact with each other are moved away from each other, an action of opening the closed mouth, and an action of opening a closed eyelid.

In the manipulation determination apparatus according to still another aspect of the present invention, the manipulation determination unit further determines a manipulation corresponding to a motion of the living body based on required conditions that the contact action or the non-contact action is performed in a state where the whole or part of the position or area is placed on a side of the boundary plane or boundary line on the computer space after passing through the boundary plane or boundary line.

In the manipulation determination apparatus according to still another aspect of the present invention, the manipulation determination unit further determines a manipulation corresponding to a motion of the living body based on required conditions that the contact action or the non-contact action is performed in a state where the whole or part of the position or area is crossing the boundary plane or boundary line on the computer space.

In the manipulation determination apparatus according to still another aspect of the present invention, the manipulation determination unit further determines a manipulation corresponding to a motion of the living body based on required conditions that the contact action or the non-contact action is performed in a state where the whole or part of the position or area is placed inside a boundary defined by the boundary plane or boundary line on the computer space.

In the manipulation determination apparatus according to still another aspect of the present invention, the manipulation determination unit further determines a manipulation corresponding to a motion of the living body based on required conditions that the living body moves toward outside of the boundary after performing the contact action or the non-contact action inside the boundary.

In the manipulation determination apparatus according to still another aspect of the present invention, the manipulation determination unit further determines a manipulation corresponding to a motion of the living body based on required conditions that a contact state established by the contact action or a non-contact state established by the non-contact action is continued while the whole or part of the position or area is passing through the boundary plane or boundary line on the computer space.

In the manipulation determination apparatus according to still another aspect of the present invention, the manipulation determination unit further determines a manipulation corresponding to a motion of the living body based on required conditions that a non-contact state is established while the whole or part of the position or area is moving from one side to the other side through the boundary plane or boundary line on the computer space, and a contact state is established while the whole or part of the position or area is moving back from the other side to the one side.

In the manipulation determination apparatus according to still another aspect of the present invention, the whole or part of the boundary plane or boundary line on the computer space is a boundary plane or boundary line recognizable by the user in a real space.

In the manipulation determination apparatus according to still another aspect of the present invention, the whole or part of the boundary plane or boundary line on the computer space is a plane or line displayed by a display unit.

In the manipulation determination apparatus according to still another aspect of the present invention, the whole or part of the boundary plane or boundary line on the computer space is a line of a display frame of a display unit.

In the manipulation determination apparatus according to still another aspect of the present invention, the allocation unit allocates the position or area onto the computer space corresponding to any of a motion of the head, a motion of an eyeball, a motion of a foot or leg, a motion of an arm, a motion of a hand or finger, and a motion of an eyeball of the user.

In the manipulation determination apparatus according to still another aspect of the present invention, the allocation unit allocates a corresponding point or linear area onto the computer space depending on a direction of a line of sight based on a state of the eyeball, and/or the allocation unit allocates a corresponding point, linear area, planar area, or three dimensional area onto the computer space based on a position or a joint bending angle of any of the head, mouth, feet, legs, arms, hands, and fingers.

In the manipulation determination apparatus according to still another aspect of the present invention, the position or area allocated on the computer space by the allocation unit is displayed by a display unit.

In the manipulation determination apparatus according to still another aspect of the present invention, while a contact state established by the contact action or a non-contact state established by the non-contact action is continued, the manipulation determination unit performs control not to release a target of a manipulation determination corresponding to the position or area at a start time of the contact action or the non-contact action.

In the manipulation determination apparatus according to still another aspect of the present invention, the manipulation determination unit performs control not to release the target of the manipulation determination by (1) moving a whole or part of a display element in conjunction with a motion of the living body, (2) storing, as a log, the position or area on the computer space at the start time of the contact action or the non-contact action, (3) nullifying a movement of the position or area in a direction which renders the target of the manipulation determination released, and/or (4) continuing holding the target of the manipulation determination at the start time of the contact action or the non-contact action.

In the manipulation determination apparatus according to still another aspect of the present invention, the manipulation is any of a menu display manipulation or hide manipulation for a display unit, a display screen display manipulation or hide manipulation, a selectable element selection manipulation or non-selection manipulation, a display screen luminance-up manipulation or luminance-down manipulation, a sound output unit volume-up manipulation or volume-down manipulation, a mute manipulation or mute-cancel manipulation, or any of a turn-on manipulation, a turn-off manipulation, an open/close manipulation, and a setting manipulation for a parameter such as a setting temperature of an apparatus controllable by the computer.

In the manipulation determination apparatus according to still another aspect of the present invention, the living body recognition unit detects a change between a contact state and a non-contact state of parts of the living body by detecting a change in an electrostatic energy of the user.

According to still another aspect of the present invention, a manipulation determination method includes a living body recognition step of recognizing a state of a living body of a user, an allocation step of allocating a first area onto a computer space such that the first area moves in conjunction with the recognized state of the living body, a change step of changing a motion of the first area in conjunction with the living body so as to make it harder for the first area to move through a second area allocated on the computer space, and a manipulation determination step of determining that a manipulation corresponding to the second area is done when the first area and the second area come to have a predetermined relation.

According to still another aspect of the present invention, a manipulation determination method includes

a living body recognition step of recognizing a state of a living body of a user, an allocation unit of allocating a first area onto a computer space such that the first area moves in conjunction with the recognized state of the living body, a change step of moving a second area allocated on the computer space such that the second area keeps away from the coming first area, and a manipulation determination step of determining that a manipulation corresponding to the second area is done when the first area and the second area come to have a predetermined relation.

According to still another aspect of the present invention, a manipulation determination method includes a living body recognition step of recognizing a state of a living body of a user, an allocation step of allocating a position or area onto a computer space such that the position or area moves in conjunction with the recognized state of the living body, and a manipulation determination step of determining a manipulation corresponding to a motion of the living body based on required conditions that a whole or part of the position or area passes through a boundary plane or boundary line on the computer space, and that parts of the living body perform a contact action or a non-contact action.

According to still another aspect of the present invention, a program causing a computer to execute a living body recognition step of recognizing a state of a living body of a user, an allocation step of allocating a first area onto a computer space such that the first area moves in conjunction with the recognized state of the living body, a change step of changing a motion of the first area in conjunction with the living body so as to make it harder for the first area to move through a second area allocated on the computer space, and a manipulation determination step of determining that a manipulation corresponding to the second area is done when the first area and the second area come to have a predetermined relation.

According to still another aspect of the present invention, a program causing a computer to execute a living body recognition step of recognizing a state of a living body of a user, an allocation unit of allocating a first area onto a computer space such that the first area moves in conjunction with the recognized state of the living body, a change step of moving a second area allocated on the computer space such that the second area keeps away from the coming first area, and a manipulation determination step of determining that a manipulation corresponding to the second area is done when the first area and the second area come to have a predetermined relation.

According to still another aspect of the present invention, a program causing a computer to execute a living body recognition step of recognizing a state of a living body of a user, an allocation step of allocating a position or area onto a computer space such that the position or area moves in conjunction with the recognized state of the living body, and a manipulation determination step of determining a manipulation corresponding to a motion of the living body based on required conditions that a whole or part of the position or area passes through a boundary plane or boundary line on the computer space, and that parts of the living body perform a contact action or a non-contact action.

According to still another aspect of the present invention, computer-readable storage medium have stored therein the aforementioned program so as to be readable by a computer.

### BRIEF DESCRIPTION OF DRAWINGS

FIG. 1 is a diagram (No. 1) schematically illustrating a case where a line segment corresponding to a glass rim is set as a boundary line, and a manipulation determination is made based on the required conditions that: (1) a real hand or fingers of a user are placed outside the glass rim; and (2) two fingers of the user perform a contact action.

FIG. 2 is a diagram (No. 2) schematically illustrating the case where the line segment corresponding to the glass rim is set as the boundary line, and the manipulation determination is made based on the required conditions that: (1) the real hand or fingers of the user are placed outside the glass rim; and (2) the two fingers of the user perform the contact action.

FIG. 3 is a diagram (No. 3) schematically illustrating the case where the line segment corresponding to the glass rim is set as the boundary line, and the manipulation determination is made based on the required conditions that: (1) the real hand or fingers of the user are placed outside the glass rim; and (2) the two fingers of the user perform the contact action.

FIG. 4 is a diagram (No. 1) schematically illustrating a case where a manipulation determination for a watch-type wearable terminal wound around the left hand is made based on the required conditions that: (1) the right hand of a user enters the proximal side beyond a boundary plane defined based on the wristband; and (2) fingers of the right hand perform a contact action.

FIG. 5 is a diagram (No. 2) schematically illustrating the case where the manipulation determination for the watch-type wearable terminal wound around the left hand is made based on the required conditions that: (1) the right hand of the user enters the proximal side beyond the boundary plane defined based on the wristband; and (2) the fingers of the right hand perform the contact action.

FIG. 6 is a diagram (No. 3) schematically illustrating the case where the manipulation determination for the watch-type wearable terminal wound around the left hand is made based on the required conditions that: (1) the right hand of the user enters the proximal side beyond the boundary plane de fined based on the wristband; and (2) the fingers of the right hand perform the contact action.

FIG. 7 is a diagram (No. 1) schematically illustrating a case where a display frame of a television screen is set as a boundary line, and a manipulation determination is made based on the required conditions that: (1) a displayed hand or fingers are placed outside the display frame; and (2) the fingers of the user perform a contact action.

FIG. 8 is a diagram (No. 2) schematically illustrating the case where the display frame of the television screen is set as the boundary line, and the manipulation determination is made based on the required conditions that: (1) the displayed hand or fingers are placed outside the display frame; and (2) the fingers of the user perform the contact action.

FIG. 9 is a diagram (No. 3) schematically illustrating the case where the display frame of the television screen is set as the boundary line, and the manipulation determination is made based on the required conditions that: (1) the displayed hand or fingers are placed outside the display frame; and (2) the fingers of the user perform the contact action.

FIG. 10 is a time-series diagram (No. 1) schematically illustrating a case where a boundary plane and a three-dimensional image of a hand are displayed on a monitor screen, and a manipulation determination is made based on the required conditions that: (1) the displayed three-dimensional image is placed outside the boundary plane in a depth direction; and (2) the fingers of the user perform a contact action.

FIG. 11 is a diagram (No. 2) schematically illustrating the case where the boundary plane and the three-dimensional image of the hand are displayed on the monitor screen, and the manipulation determination is made based on the required conditions that: (1) the displayed three-dimensional image is placed outside the boundary plane in the depth direction; and (2) the fingers of the user perform the contact action.

FIG. 12 is a diagram (No. 3) schematically illustrating the case where the boundary plane and the three-dimensional image of the hand are displayed on the monitor screen, and the manipulation determination is made based on the required conditions that: (1) the displayed three-dimensional image is placed outside the boundary plane in the depth direction; and (2) the fingers of the user perform the contact action.

FIG. 13 is a schematic diagram (No. 1) explaining that, if two fingers catch a point by encircling the point, it is possible to determine that the two fingers move beyond a particular boundary line including the point (1) and perform the contact action (2).

FIG. 14 is a schematic diagram (No. 2) explaining that, if the two fingers catch the point by encircling the point, it is possible to determine that the two fingers move beyond the particular boundary line including the point (1) and perform the contact action (2).

FIG. 15 is a diagram illustrating an example of a three-dimensional topological determination.

FIG. 16 is a diagram illustrating the example of the three-dimensional topological determination.

FIG. 17 is a diagram (No. 1) schematically illustrating a case where a line segment corresponding to a frame of a display screen is set as a boundary line, and a manipulation determination is made based on the required conditions that: (1) the point of gaze of a user stays outside the display screen; and (2) the user performs a contact action of closing one eye.

FIG. 18 is a diagram (No. 2) schematically illustrating the case where the line segment corresponding to the frame of the display screen is set as the boundary line, and the manipulation determination is made based on the required conditions that: (1) the point of gaze of the user stays outside the display screen; and (2) the user performs the contact action of closing one eye.

FIG. 19 is a diagram (No. 3) schematically illustrating the case where the line segment corresponding to the frame of the display screen is set as the boundary line, and the manipulation determination is made based on the required conditions that: (1) the point of gaze of the user stays outside the display screen; and (2) the user performs the contact action of closing one eye.

FIG. 20 is a time-series diagram schematically illustrating a case where a border between an eyelid and an eyeball is set as a boundary line and a manipulation determination is made based on the required conditions that a user performs a predetermined eyeball movement inside the eyelid (1) while continuing a contact action of closing the eyelid (2).

FIG. 21 is a time-series diagram schematically illustrating the case where the border between the eyelid and the eyeball is set as the boundary line and the manipulation determination is made based on the required conditions that the user performs the predetermined eyeball movement inside the eyelid (1) while continuing the contact action of closing the eyelid (2).

FIG. 22 is a time-series diagram schematically illustrating the case where the border between the eyelid and the eyeball is set as the boundary line and the manipulation determination is made based on the required conditions that the user performs the predetermined eyeball movement inside the eyelid (1) while continuing the contact action of closing the eyelid (2).

FIG. 23 is a diagram schematically illustrating a manipulation determination method further including conditions (3-3).

FIG. 24 is a diagram schematically illustrating the manipulation determination method further including the conditions (3-3).

FIG. 25 is a diagram schematically illustrating the manipulation determination method further including the conditions (3-3).

FIG. 26 is a block diagram illustrating an example of a configuration of a manipulation determination apparatus 100 to which the present embodiment is applied.

FIG. 27 is a flowchart presenting an example of display information processing of the manipulation determination apparatus 100 in the present embodiment.

FIG. 28 is a diagram illustrating an example of an external appearance of a display device 114 including a display screen displayed under the control of a boundary setting unit 102a.

FIG. 29 is a diagram illustrating an example of a display screen in which a representation of a user is superimposed and displayed on an initial screen in FIG. 28.

FIG. 30 is a display screen example illustrating an example of a point P2 under keeping-out movement control by a position change unit 102b.

FIG. 31 is one of transition diagrams schematically illustrating a transition of first areas and a second area along with first keeping-out movement control.

FIG. 32 is one of the transition diagrams schematically illustrating the transition of the first areas and the second area along with the first keeping-out movement control.

FIG. 33 is one of the transition diagrams schematically illustrating the transition of the first areas and the second area along with the first keeping-out movement control.

FIG. 34 is one of the transition diagrams schematically illustrating the transition of the first areas and the second area along with the first keeping-out movement control.

### MODES FOR CARRYING OUT THE INVENTION

Hereinafter, a manipulation determination apparatus, a manipulation determination method, and a program according to embodiments of the present invention, and an embodiment of a storage medium are described in details based on the drawings. It should be noted that the invention should not be limited by the embodiments.

### General Description of Embodiment

Hereinafter, a general description of an embodiment according to the present invention is described, and then a configuration, processing and the like of the present embodiment are described in details. It should be noted that the general description below described should not be interpreted as limiting the configuration and processing of the present embodiment described later.

Sensors and devices have been developed for inputting a body motion of a user, or a state of the living body to a computer. For example, the KINECT sensor manufactured by Microsoft Corporation is capable of performing gesture inputs of the position information, speed and acceleration information, and the like of various parts of the skeleton of a user. Meanwhile, the Leap Motion sensor manufactured by Leap Motion, Inc. is capable of inputting position information of a finger of a user. Then, a 3D camera using a Real technology of Intel Corporation is capable of inputting a motion of a human body or fingertips. An eye tracking technology sensor manufactured by Tobii AB is capable of inputting an eye line (line of sight) or a point of gaze. In addition, by reading an ocular potential, this sensor is also capable of detecting an eyeball movement, and detecting an opening/closing of an eyelid or a point of gaze.

As described above, the sensors and the like have been developed which are capable of handling a natural body motion of a user as an input to a computer. However, there is a possibility that the user may perform an improper input because a body motion is analog and continuous in nature. For example, let us consider a case where a user presses down a virtual keyboard on a computer space by inputting a finger motion to a computer via the aforementioned Leap Motion sensor. When an image moving in conjunction with a hand of the user is displayed on a manipulation screen and the user concentrates on performing inputs to the virtual keyboard, the user is less likely to perform a wrong action. However, when the user looks aside from the manipulation screen, or when the manipulation screen is temporarily hidden, the user may sometimes perform an unintended input by taking an improper motion of the hand of the user.

In particular, with recently developed wearable terminals such as glasses-type and watch-type terminals, a tendency for a user to perform an unintended manipulation by conducting a usual motion is considered to become even more remarkable, because there are cases where the display area is very limited, and display means is not provided or is temporarily hidden, for example.

The present inventor has earnestly studied the aforementioned problem and has accomplished the development of the present invention. An embodiment of the present invention employs a condition (1) that a manipulable range is limited by a border such as a boundary plane or boundary line provided with respect to a change in a continuous position or area corresponding to a body motion. Then, the embodiment of the present invention employs another condition (2) that a binary and haptic change is required, such as an action of changing a contact state of parts of the living body to a non-contact state (referred to as a “non-contact action” in the present embodiment), or an action of changing a non-contact state of parts of the living body to a contact state (referred to as a “contact action” in the present embodiment). The embodiment of the present invention is characterized by using a combination of these conditions (1) and (2) to reduce the possibility that a user may perform an unintended manipulation.

In the present embodiment, the continuous position or area corresponding to a body motion is allocated onto a computer space, and is moved in conjunction with the motion of a user. Here, the computer space may be two-dimensional or three-dimensional. In addition, the boundary line or boundary plane is not limited to a line or plane fixedly set in advance on the computer space. Instead, a sensor such as the various sensors described above may read a certain thing which can serve as the boundary line or boundary plane in an actual space, when detecting a motion of the user. For example, the boundary line or boundary plane may be set based on the detected body of the user. In one example, if the right hand is used for a manipulation, the body axis at the backbone may be set as the boundary line or boundary plane, and a limit may be provided such that a manipulation determination should not be made unless the right hand is moved on the left side of the body. Otherwise, the boundary line or boundary plane may be set based on a certain thing worn by the user (such as a wearable terminal or glasses).

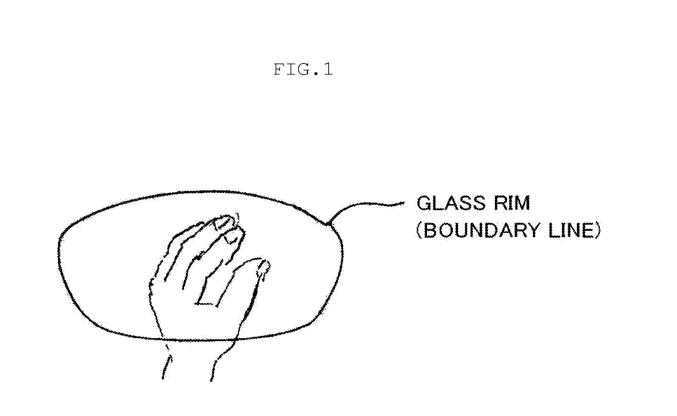

Note that it does not matter whether or not the position or area allocated on the computer and the boundary line or boundary plane space is displayed on a display screen. In the case of Google Glass manufactured by Google Inc. or Meta glasses manufactured by Meta Company, for example, light of user's real hand, fingers or the like reaches the eyes through a display screen, so that the user can recognize the light. In this case, there is no need to take effort to display an image that moves in conjunction with the user's hand or fingers. In the case of such a glasses-type wearable terminal, as one example as illustrated in FIGS. 1 to 3 in the present embodiment, a line segment corresponding to a glass rim may be set as the boundary line, and a manipulation determination may be made based on the required conditions that: (1) a real hand or fingers of the user are placed outside the glass rim; and (2) two fingers of the user perform a contact action.

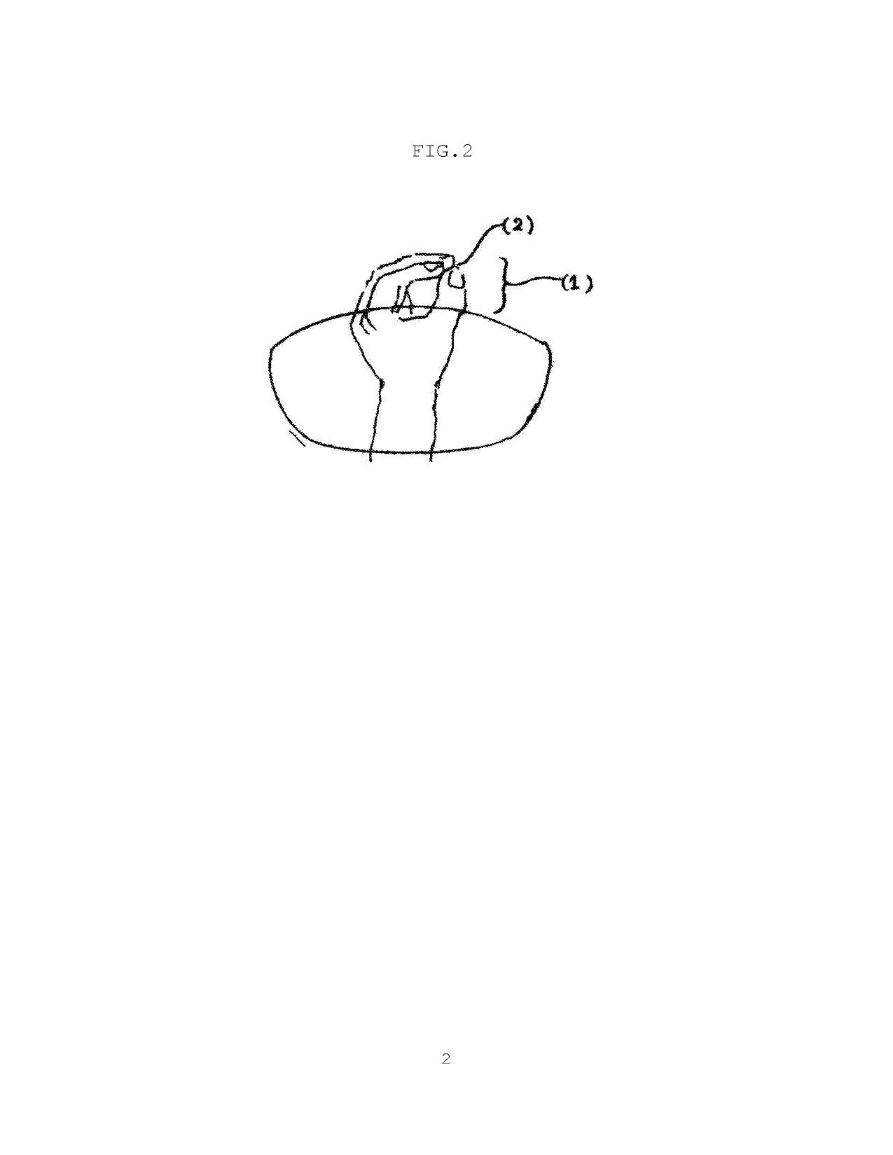

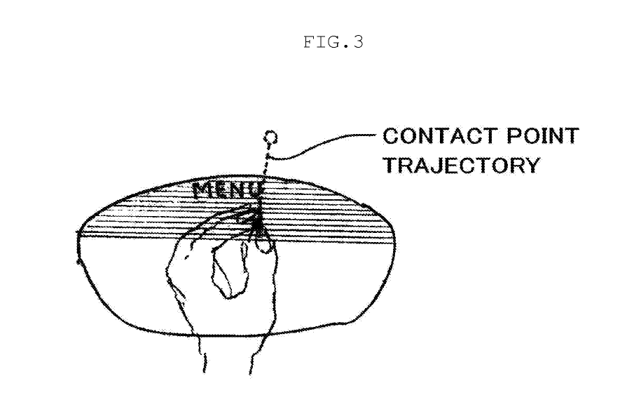

Here, FIGS. 1 to 3 are time-series diagrams schematically illustrating a case where the line segment corresponding to the glass rim is set as the boundary line and a manipulation determination is made based on the required conditions that: (1) a real hand or fingers of a user are placed outside the glass rim; and (2) two fingers of the user perform a contact action. These drawings illustrate the states viewed from the eye of the user wearing the glasses-type terminal. In this example, the glass rim is set as the boundary line as illustrated in FIG. 1. As for the boundary line, a line corresponding to the rim on the computer space is set as the actual boundary line. In addition, although the boundary line may be used to make a determination based on a two-dimensional area of the hand or fingers on the computer space, a boundary plane containing the boundary line and extending in the eye line direction may also be used to make a determination based on a three-dimensional area of the hand or fingers. As illustrated in FIG. 2, when the user holds up the hand and fingers outside a field of view through the glass (1) and performs a contact action of pinching (2), the action is determined as a motion with an intension to manipulate the glasses-type terminal. In this example, the user can perform a menu display manipulation by moving the contact point of the fingertips to the inside of the field of view of the glass as illustrated in FIG. 3.

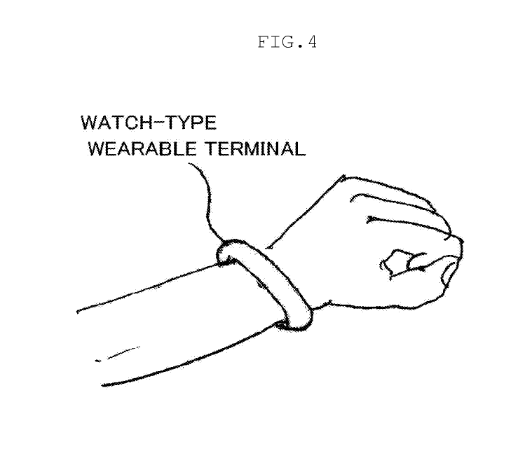

In the case of a watch-type wearable terminal as another example, a plane defined based on a ring-shaped band wound around an arm may be set as the boundary plane. More specifically, as illustrated in FIGS. 4 to 6, in the case where the watch-type wearable terminal is wound around the left hand, a manipulation determination may be made based on the required conditions that: (1) the right hand of the user is moved from the distal side to the proximal side of the hand beyond the ring plane (boundary plane); and (2) fingers of the right hand perform a contact action.

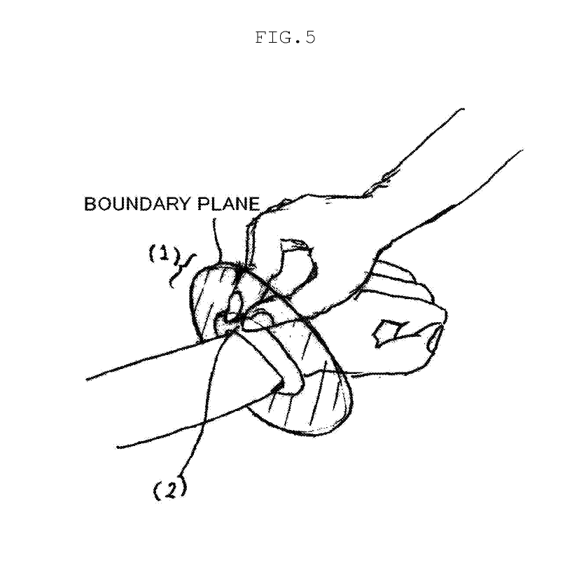

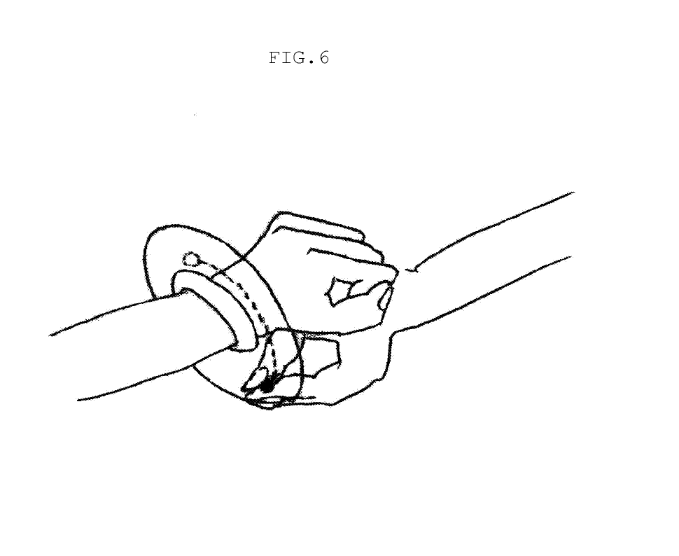

FIGS. 4 to 6 are time-series diagrams schematically illustrating a case where a manipulation determination for a watch-type wearable terminal wound around the left hand is made based on the required conditions that: (1) the right hand of the user is moved to the proximal side beyond the boundary plane defined based on the wristband; and (2) fingers of the right hand perform a contact action. In this example, as illustrated in FIG. 4, a plane including a circle of the wristband of the watch-type terminal and having an area with a predetermined radius from the center of the circle is set as the boundary plane. As illustrated in FIG. 5, when (1) the right hand of the user is moved from the distal side to the proximal side of the left arm beyond the boundary plane of the wristband, and (2) performs a contact action in which the thumb of the right hand comes into contact with the lateral side of the forefinger, the action is determined as an action in which the user has an intension to manipulate the terminal. In this example, as illustrated in FIG. 6, the user can continuously perform a time adjustment manipulation by rotating the right hand around the left arm while keeping the contact in the contact action. For example, the setting time of an alarm or the like can be advanced by one minute every time the right hand in the contact state moves by 6 degrees around the left arm, and a manipulation to advance by 30 minutes can be performed when the right hand makes a half circuit around the left arm (a manipulation to retard the setting time can be performed by the reverse rotation of the right hand). The user can fix the setting time by, at a desired position, bringing the fingers of the right hand out of contact with each other, or withdrawing the right hand to the distal side beyond the boundary plane.

Here, the boundary line or boundary plane does not have to be a mathematical infinitely continuous line or plane, but may be a curve line, a line segment, or a plane having a certain area. In the present embodiment, depending on spatial dimensions or the like of a position or area to be handled, a determination may be made based on a boundary plane even if a boundary line is mentioned, or vice versa a determination may be made based on a boundary line even if a boundary plane is mentioned. For example, even if a display frame or a glass frame is mentioned to be set as a boundary line, a determination may be made by using, as a boundary plane, a plane including the display frame or the glass frame (for example, a plane including a line segment of the frame and the line of sight) in a case where a hand, fingers, or the like on the computer space is allocated as a three-dimensional area instead of a two-dimensional area like a shaded image.

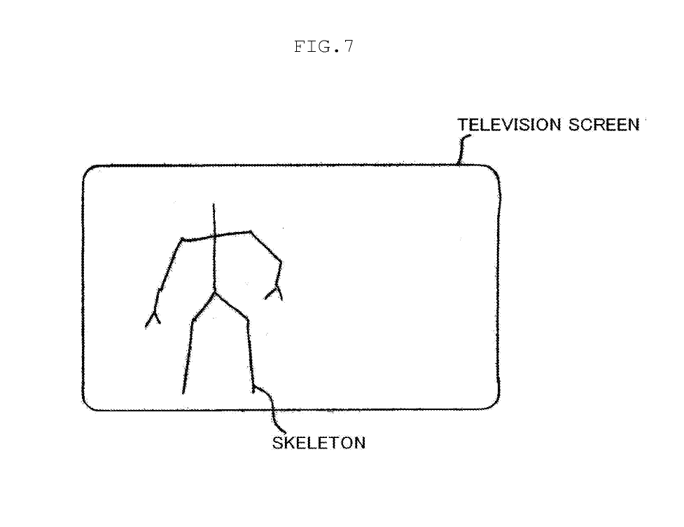

As still another example, illustrated is a case where an image moving in conjunction with a hand or fingers of a user is displayed on a display screen of a television, a monitor, or the like by using a motion sensor such as a Kinect sensor manufactured by Microsoft Corporation or a Leap sensor manufactured by Leap Motion, Inc. In this case, as illustrated in FIGS. 7 to 9, the display frame of the television or the monitor is set as the boundary line, and a determination may be made based on the required conditions that: (1) the displayed hand or fingers are placed outside the display frame (for example, the fingertips or the like are not displayed); and (2) the fingers of the user perform a contact action.

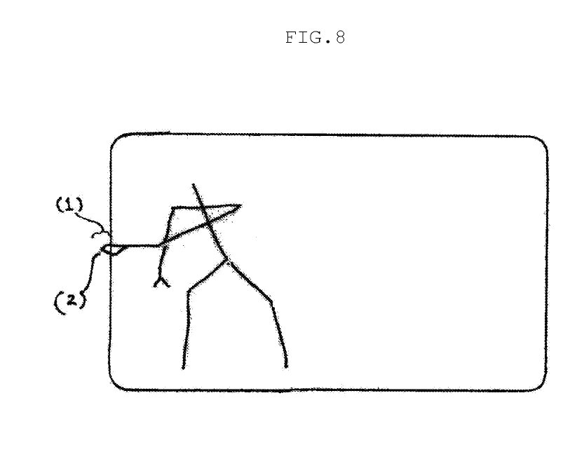

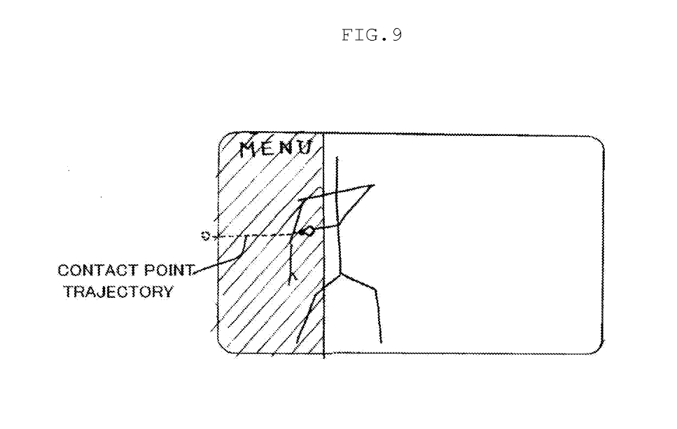

Here, FIGS. 7 to 9 are time-series diagrams schematically illustrating a case where the display frame of a television screen is set as the boundary line, and a manipulation determination is made based on the required conditions that: (1) the displayed hand or fingers are placed outside the display frame; and (2) the fingers of the user perform a contact action. In this example, as illustrated in FIG. 7, the frame of the television screen is set as the boundary line, and the skeleton of the user read by means of the motion sensor is displayed on the television screen. As illustrated in FIG. 8, when the user moves the right hand such that the skeleton gets out of the television display screen (1), and performs a contact action of forming a first of the right hand (2), the action is determined as a motion with an intension to perform a device manipulation. In this case, the skeleton of the right hand is not displayed on the television screen, but is still within a detection range of the motion sensor. Thus, the aforementioned determination of (1) and 2 can be made. In this example, as illustrated in FIG. 9, the user performs a search screen display manipulation by moving the contact point where the right hand forms the first to the inside of the television screen.

Instead, in the case where a three-dimensional image moving in conjunction with a hand or fingers of a user is displayed on a display screen of a television, a monitor, or the like by using a motion sensor, a surface of a virtual object such as a virtual keyboard displayed on the display screen may be set as the boundary plane, and a manipulation determination may be made based on the required conditions that: (1) the displayed hand or fingers are placed inside the virtual object such as the virtual keyboard, and (2) two fingers of the user perform a contact action.

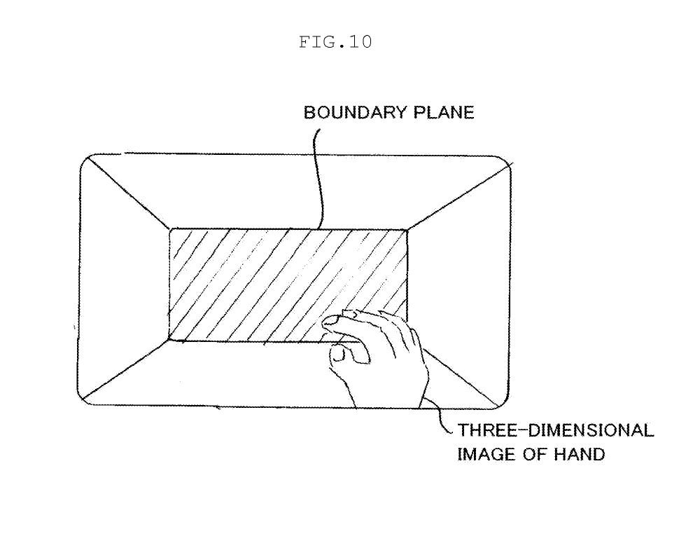

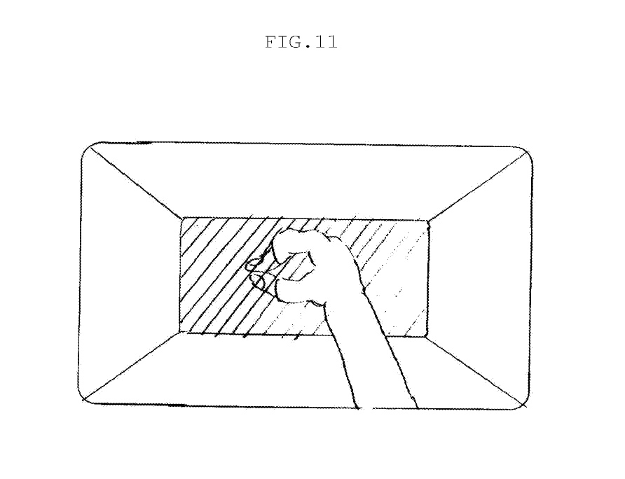

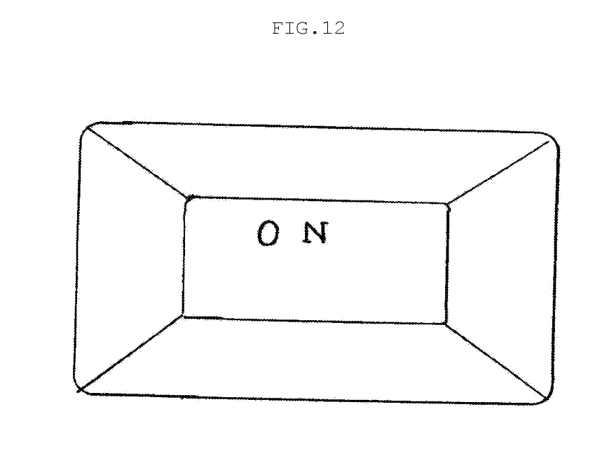

Here, FIGS. 10 to 12 are time-series diagrams schematically illustrating a case where a boundary plane and a three-dimensional image of a hand are displayed on a monitor screen, and a manipulation determination is made based on the required conditions that: (1) the displayed three-dimensional image is placed outside the boundary plane in a depth direction; and (2) the fingers of the user perform a contact action. In this example, as illustrated in FIG. 10, the boundary plane is displayed as a surface of a three-dimensional virtual object on the monitor, and a three-dimensional image moving in conjunction with a motion of the hand or fingers is also displayed together. As illustrated in FIG. 11, when the three-dimensional image of the hand enters the inside of the virtual object through the boundary plane (1), and the fingertips perform the contact action (2), the action is determined as a motion with an intension to perform a manipulation. As illustrated in FIG. 12, this example may be configured as a manipulation equivalent to a click manipulation on a displayed GUI screen, whereby, for example, an ON/OFF manipulation of a switch of a connected external instrument, a manipulation of pressing down a link indicator of a web page or the like, and other manipulations can be performed. Although not illustrated, if the surface of a virtual keyboard is set as the boundary plane, the user may perform a keyboard manipulation corresponding to a position in the keyboard where the above (1) and (2) are satisfied.

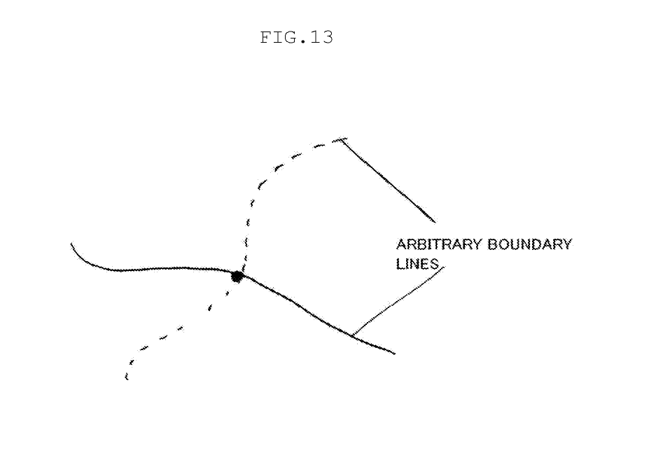

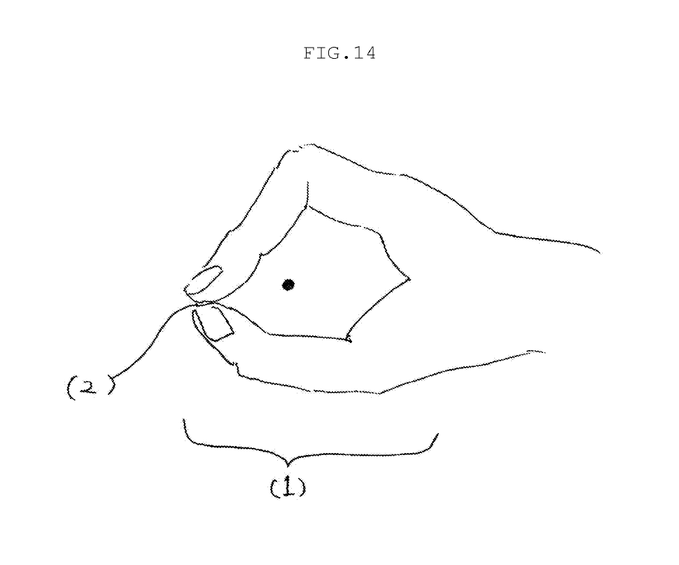

Here, the boundary line or boundary plane may be displayed on the display screen not only in the form of a line or a plane, but also in the form of a point. For example, as illustrated in FIGS. 13 and 14, a hand or fingers of a user may be allocated as a two-dimensional area like a shaded image onto a computer space and displayed, and a representative point of a boundary line may be displayed on the two-dimensional plane. In this case, when the point is caught with two fingers in an encircled manner (for example, the point is placed inside a closed ring formed with the fingertips of the thumb and forefinger touching each other), the user and a computer can determine that the contact action (2) is performed beyond a certain boundary line including the point (1). Thus, the boundary line does not always have to be displayed as a line on the display screen, but may be displayed as a point. In this way, the boundary line may be regarded as a certain line segment including a point, and a manipulation determination of (1) and (2) may be made topologically. As another example of the case where an opened-ring state formed by the thumb and the forefinger is changed to a closed-ring state in which a figure such as a point is encircled, it is possible to determine that the conditions (1) and (2) are met when an opened-ring state formed by two arms is changed to a closed-ring state in which a figure such as a point is encircled.

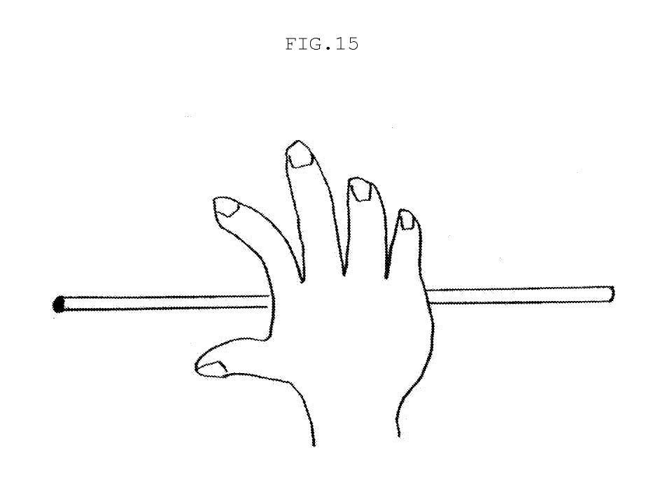

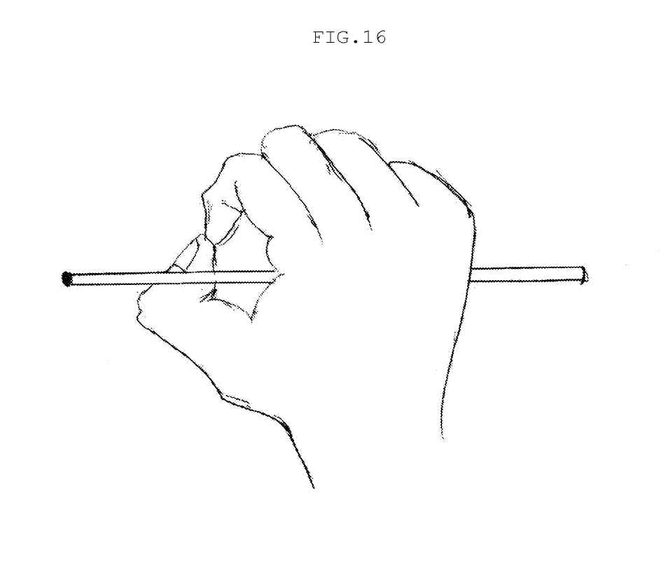

Similarly, in a case where a hand or fingers of a user is allocated as a three-dimensional area onto a computer space and a representative line segment of a boundary plane is displayed, the user and a computer can determine that the contact action (2) is performed beyond a particular boundary plane including the line segment (1), when the line segment is caught in an encircled manner with the three-dimensionally displayed image of the hand or fingers (for example, the line segment is grabbed by the skeleton of the hand on the display). Thus, the boundary plane does not always have to be displayed in the form of a plane on the display screen, but just have to be recognizable as a line segment. If FIGS. 13 and 14 are considered to be drawings viewed in a direction of the line segment, FIGS. 13 and 14 can be seen as references for an example of such three-dimensional topological determination. Here, FIGS. 15 and 16 are diagrams illustrating an example of the three-dimensional topological determination. In other words, a certain boundary plane passing through a line segment is considered to be present.

When a user stretches a hand toward the line segment as illustrated in FIG. 15 and an image of the hand or fingers grabs the line segment in an encircled manner as illustrated in FIG. 16, a manipulation determination is made by determining that the contact action is performed (2) beyond the particular boundary plane including the line segment (1). In a case where a hand or fingers of a user are allocated as a three-dimensional area onto the computer space, the recognized hand of the user does not necessarily have to be displayed. This is because the user can perform a manipulation while viewing the real image of his/her own hand. Similarly, the line segment may also be a displayed line segment, or may be a rod or the like in the real world. This is because the computer can make the manipulation determination if the computer can correctly recognize a positional relation between the hand of the user and the line segment on the computer space. In this way, the conditions (1) and (2) may be determined to be met when, for example, the three-dimensional skeleton formed with a thumb and a forefront finer is changed from the opened-ring state to the closed-ring state in which a figure such as a line segment is encircled.

### [Keeping-Out Movement Control]

Here, in order to improve manipulability, a representative point of a boundary line, a representative boundary line of a boundary plane, the boundary plane, a line segment, or the like may be moved to keep out of an area of a body part such as a hand or fingers. The following describes this control.

Nowadays, development on head mount displays, smart televisions, and the like has been in progress. For example, the input device described in Patent Document 1 is disclosed such that the input device captures an image of a hand or finger which an input person points toward the display without using a remote controller, displays a cursor on the display to show a position on the display corresponding to the direction in which the hand or finger is pointed at the display, and selects information in a portion where the cursor is positioned as information submitted by the input person when detecting a click action of the hand or finger.

Here, a manipulation of selecting an element on a screen without using a remote controller as in a conventional technique (such as Patent Document 1) has nature decisively different from that of a method using a mouse or a tough pad in the following points.

Specifically, heretofore, in the case of manipulating a mouse or touch pad by using a graphic user interface (GUI) presented on a screen, a user firstly <i> makes positioning to place a cursor on an element on the screen; and then <ii> selects the element on the screen by performing a decision manipulation such as a click after confirming the position.

In the case of manipulation with a device such as a mouse or touch pad, a dynamic frictional force and a static frictional force act. For this reason, it is less likely that the user will perform a wrong manipulation due to a displacement during a period from <i> the positioning to <ii> the decision manipulation.

If this manipulation method including <i> and <ii> is directly applied to a remote-controller-less television or the like, a user needs to <i> perform a positioning manipulation by moving a cursor on a screen with his/her finger or hand held in the air, and <ii> perform a decision manipulation by moving the finger or hand in a predetermined action, as described in Patent Document 1.

Since no friction acts on the finger or hand held in the air, the following problems are considered to arise: the finger or hand tends to move freely and be displaced during the period from <i> the positioning manipulation to <ii> the decision manipulation and therefore to perform a wrong manipulation; and the displacement may highly possibly occur particularly in an attempt to take the action for <ii> the decision manipulation.

Therefore, the inventor of the present application has earnestly studied with the above problems taken into account, and has accomplished another aspect of the present invention. The other aspect of the present invention has the following features.

To be specific, in the present embodiment, a state of a living body of a user is recognized. For example, an image (whether two-dimensional or three-dimensional) of a person, the image being captured with a detection unit may be obtained.

Then, in the present embodiment, a position or area (this position or area is referred to as a “first area” for convenience) is allocated onto a computer space such that the first area may move in conjunction with the recognized state of the living body. In this connection, in the present embodiment, the position or area on the computer space may be displayed and presented to the user. For example, circles may be displayed at positions corresponding to the respective fingers of the user, or the skeleton of the hand of the user may be displayed.

Then, in the present embodiment, a position or area (this position or area is referred to as a “second area” for convenience) corresponding to each selectable element is allocated onto the computer space. The first area may be any of one-dimensional, two-dimensional, and three-dimensional areas, whereas the second area may be any of zero-dimensional, one-dimensional, two-dimensional, and three-dimensional areas. In one example, the second area may be a representative point of a boundary line, a representative boundary line of a boundary plane, a boundary plane, a line segment, or the like. Note that, in the present embodiment, the second area may be displayed, but does not have to be displayed in the case where the second area is recognizable by the user in the real space, as in the case of the foregoing glass rim.

Then, in the present embodiment, when the coming first area comes close to or into contact with the second area, a motion of the first area in conjunction with the living body is changed to make it harder for the first area to move through the second area (referred to as “first keeping-out movement control”). For example, in order to delay the conjunctive motion, a time lag may be generated, the speed may be decreased, or a pitch of the conjunctive motion may be made smaller. For example, when the first area moving in conjunction with a motion of the living body comes into contact with the second area, the first area may be stopped from moving for a predetermined period of time irrespective of the motion of the living body. Then, after the predetermined period of time passes, the first area may be again allocated so as to move in conjunction with the motion of the living body in the present embodiment. Note that, in the way opposite to that of the first keeping-out movement control in which the motion of the first area is changed with the second area fixed, the present embodiment may employ keeping-out movement control in which the second area is moved to keep away from the coming first area (referred to as “second keeping-out movement control”). Here, as the keeping-out movement control, any of the following cases may be employed: a case where the area concerned is moved while the two areas are kept in contact with each other; a case where the area is moved while the two areas overlap with each other to a certain degree; and a case where the area is moved while the areas are kept at a certain distance from each other (like the south poles of magnets). Further, while the first movement control of changing the motion of the first area is being performed, the second keeping-out movement control may be performed so that the first area and the second area may interact with each other. In this case, an execution ratio between the first keeping-out movement control and the second keeping-out movement movement control, or more specifically a ratio between a movement amount of the first area relatively moved contrary to the motion of the living body under the first keeping-out movement control, and a movement amount of the second area moved to avoid the first area under the second keeping-out movement control may be set as needed. Both the first keeping-out movement control and the second keeping-out movement control similarly prevent the first area that moves in conjunction with the living body from moving through the second area, and thereby contribute to the improvement in the manipulability.

In the present embodiment, it is determined that a manipulation intended by the user is done when the first area and/or the second area turns into a predetermined state, for example, a predetermined moved state (such as a predetermined movement degree or a predetermined post-movement position). Here, the present embodiment is not limited to the manipulation determination based on the moved state, but also the manipulation determination may be made based on an action. For example, in the present embodiment, when a predetermined action such as an action of closing an opened hand is performed, the manipulation determination may be made by determining the predetermined state is established.

With this configuration, the present embodiment enables the manipulation selection and decision as in the <i> and <ii> to be done without performing <i> the conventional positioning of a mouse pointer, a cursor, or the like. Specifically, as is the case with the <i>, the user can confirm the selection of a manipulation by intuitively performing a manipulation such as grabbing, holding, catching, pressing, nipping or hitting of an object (second area) in the real space or virtual space with his/her own body (first area). Then, after the confirmation, the user can control the state (such as the movement degree or the post-movement position) by intuitively performing a manipulation such as grabbing and pulling, holding for a certain time, catching and pulling down, pushing up, nipping and pulling, or throwing by hitting, and thereby can submit a decision of the manipulation selection as in the <ii>. Here, in the case where the manipulation is judged as selected not based on the moved state but based on an action, the user can control the state, after the confirmation, by intuitively taking an action manipulation such as grabbing and squeezing, gripping while holding, catching and then removing the hand with acceleration, pushing up and throwing away, nipping and then making the two fingers come together, or touching and then snapping, and thus can submit the decision of the manipulation selection as in the <ii>.

Accordingly, it is possible to reduce the uncertainty in the positioning due to a manipulation using a motion of a hand, fingers, or the like held up in the air, and to contribute to significant improvement in manipulability.

### [Eye-Related Embodiment]

Next, an eyeball movement is described below as an embodiment of a manipulation determination method based on the required conditions that (1) a position or area allocated on a computer space partially or entirely passes through a boundary plane or boundary line, and (2) parts of the living body perform a contact action or a non-contact action.

An eyeball-related example is a case where a point of gaze is inputted to a computer by using an eye tracking technology sensor manufactured by Tobii AB or the like, and, in this case, the frame of the display screen may be set as a boundary line. For example, in the present embodiment, a manipulation determination may be made when a user looking aside from the display screen (1) closes one of the eyes (2).

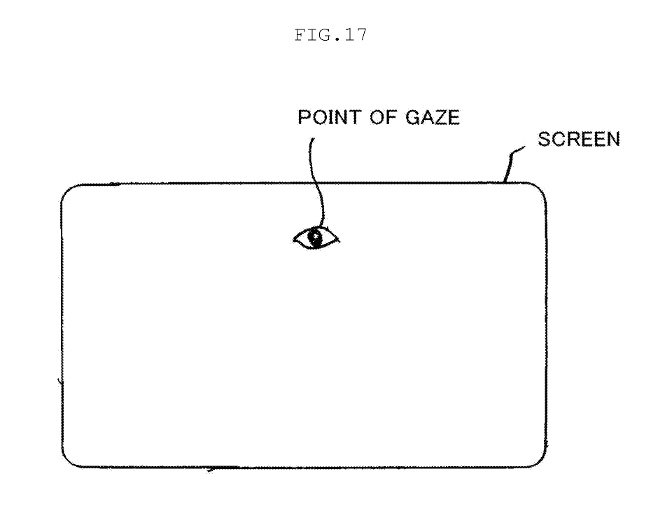

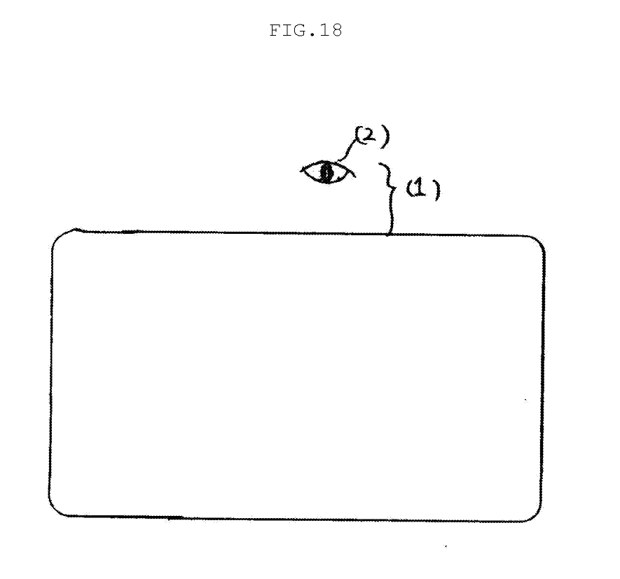

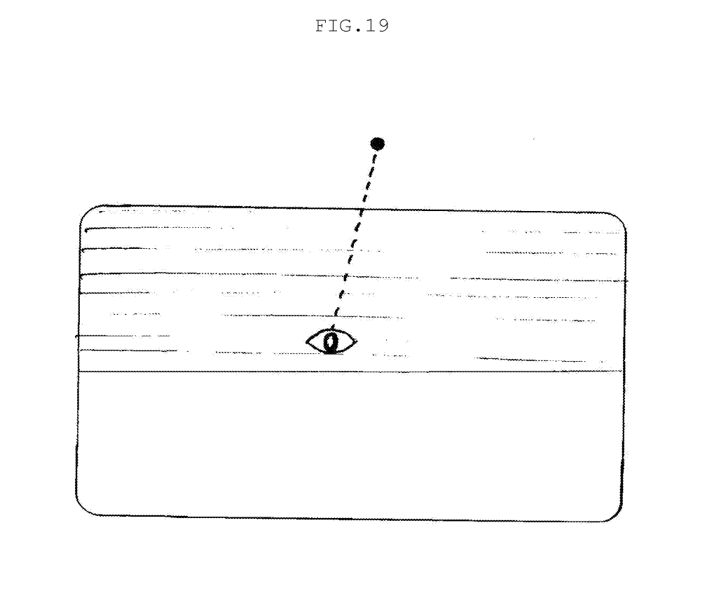

Here, FIGS. 17 to 19 are time-series diagrams schematically illustrating a case where a line segment corresponding to the frame of the display screen is set as the boundary line, and a manipulation determination is made based on the required conditions that: (1) the point of gaze of a user stays outside the display screen; and (2) the user performs a contact action of closing one of the eyes. Here, an eye mark indicates the position of the point of gaze with respect to the display screen. In this example, the frame of the display screen is set as the boundary line as illustrated in FIG. 17. Note that it does not matter whether or not the eye mark indicating the point of gaze is displayed on the screen. As illustrated in FIG. 18, when the user (1) keeping an eye aside from the screen (2) gives a so-called wink, i.e., performs a contact action of closing the eye, the action is determined as a motion with an intension to manipulate the terminal. In this example, the user can perform a menu display manipulation by moving the point of gaze back to the display screen as illustrated in FIG. 19.

Another eyeball-related example is a case where a point of gaze is tracked by using an ocular potential sensor such as MEME manufactured by JIN CO., LTD, and in this case, a boundary line may be set at a border between an external world visible area and an external world invisible area (such as the back side of an eyelid) in the subjective view of the user. For example, in the present embodiment, the manipulation determination may be made when the user (1) keeping the eyelid closed (2) performs a predetermined eyeball gesture (for example, rotates the eyeball many times).

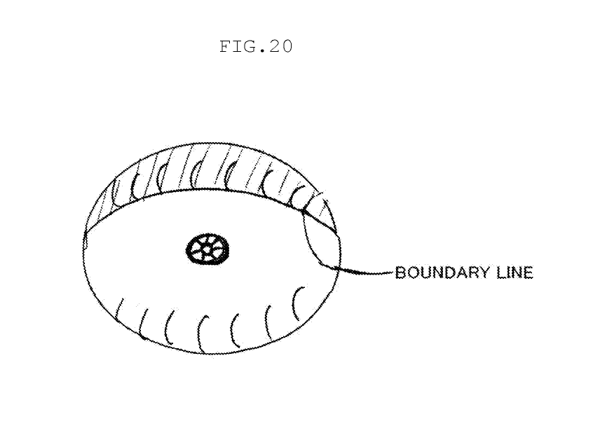

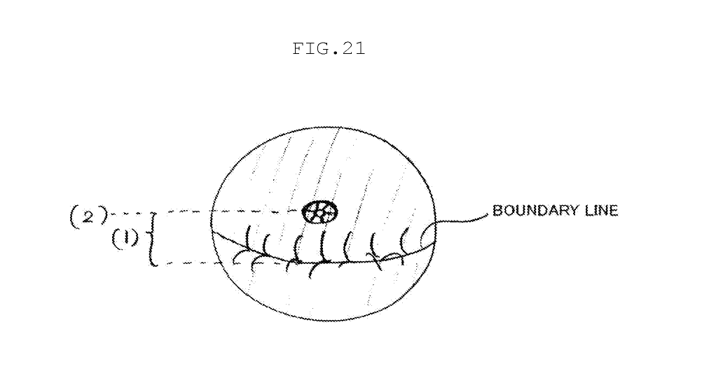

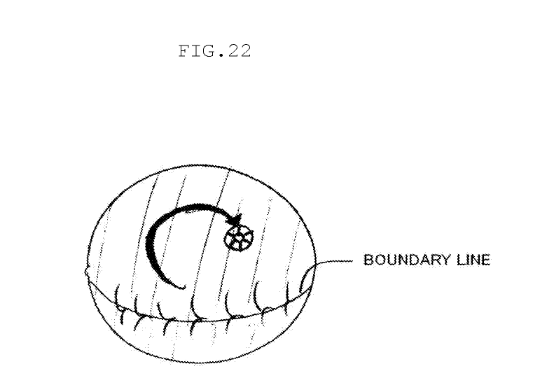

Here, FIGS. 20 to 22 are time-series diagrams schematically illustrating a case where a boundary line is set at a border between an eyelid and an eyeball and a manipulation determination is made based on the required conditions that the user performs a predetermined eyeball movement inside the eyelid (1) while continuing a contact action of closing the eyelid (2). Here, the eyeball sensing with a camera or the like is difficult when the eyelid is closed, but use of the ocular potential sensor such as MEME manufactured by JIN CO., LTD. makes it possible to detect a user's eyelid opening/closing movement or eyeball movement. A human in an active time (non-sleeping time) tends to momentarily blink his/her eyes, and rarely move the eyeballs with the eyes closed. By use of this, an eyeball movement with the eye closed is set as a trigger for a manipulation, whereby an unintended manipulation can be prevented. Here, as illustrated in FIGS. 21 and 22, when the user (1) rotates the eyeball clockwise many times while (2) keeping the eye closed, the rotation is determined as a motion with an intension to manipulate the terminal. In a manipulation example in a case where the terminal is a music player, an action in which the user performs clockwise rotations of the eyeball with the eye closed may be determined a volume-up manipulation corresponding to the number of rotations, and an action in which the user performs anticlockwise rotations of the eyeball with the eye closed may be determined a volume-down corresponding to the number of rotations.

As described above, in the present embodiment, the manipulation determination is made based on the required conditions that (1) the user passes through a recognizable boundary line or boundary plane, and (2) parts of the living body of the user perform a contact action or a non-contact action. In the examples described above, the contact action of two fingers and the contact action of the eyelid are mainly explained as the contact action of parts of the living body, but the contact action is not limited to these. Besides an action of bringing at least two fingertips or finger pads into contact with each other, any of the following actions may be employed: an action of joining and touching at least two fingers together (such as an action of changing a scissors-form hand from an opened-scissors form to a closed-scissors form); an action of closing a flat open hand (such as an action of forming a first); an action of laying down a thumb in a standing state; an action of bringing a hand or finger into contact with a part of the body; an action of bringing both hands or both feet into contact with each other; and an action of closing the opened mouth.

In addition, in the foregoing embodiments, the contact actions from the non-contact state to the contact state are described as the examples, but employable actions are not limited to these. Instead, a determination may be made based on a non-contact action from a contact state to a non-contact state. For example, any of the following non-contact actions performed by parts of the living body may be employed: an action in which at least two fingertips or finger pads in contact with each other are moved away from each other; an action in which two fingers whose lateral sides are in contact with each other are moved away from each other; an action of opening a closed hand; an action of raising up a thumb in a lying state; an action in which a hand or finger in contact with a part of the body is moved away from the part; an action in which both hands or both legs in contact with each other are moved away from each other; an action of opening the closed mouth; an action of opening a closed eyelid; and the like.

Here, in addition to the aforementioned conditions (1) and (2), required conditions (3) may be further added in order to further reduce wrong actions.

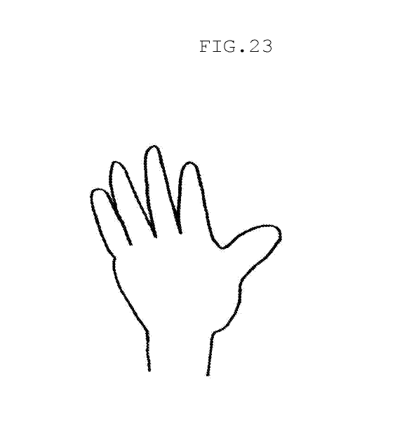

For example, the present embodiment may employ a required condition (3-1) that a contact action or a non-contact action is performed in a state where a whole or part of the allocated position or area is placed on a side of the boundary plane or boundary line on the computer space after passing through the boundary plane or line, is placed inside the boundary, or is crossing the boundary. Note that any of the two sides divided by a boundary plane or boundary line may be selected and set as a manipulable range (such as the inside of the boundary) as needed. Usually, if a side to which a user is more unlikely to come close while moving naturally is set as a manipulation target range (such as the inside of the boundary), the user is less likely to perform a wrong action. Alternatively, the present embodiment may employ a required condition (3-2) that a living body moves toward the outside of a boundary after performing a contact action or a non-contact action inside the boundary. Besides, the present embodiment may employ a required condition (3-3) that a contact state established by a contact action or a non-contact state established by a non-contact action is continued while a whole or part of the allocated position or area is passing through a boundary plane or boundary line on a computer space. Instead, the present embodiment may employ required conditions (3-3) that a non-contact state is continued while a whole or part of the allocated position or area is moving from one side to the other side through a boundary plane or boundary line on a computer space, and a contact state is continued while a whole or part of the position or area is moving back from the other side to the one side. Here, FIGS. 23 to 25 are diagrams schematically illustrating a manipulation determination method further including the conditions (3-3).

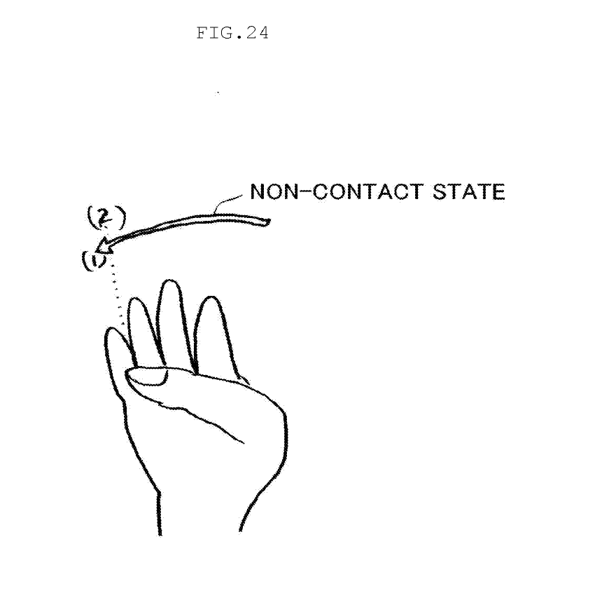

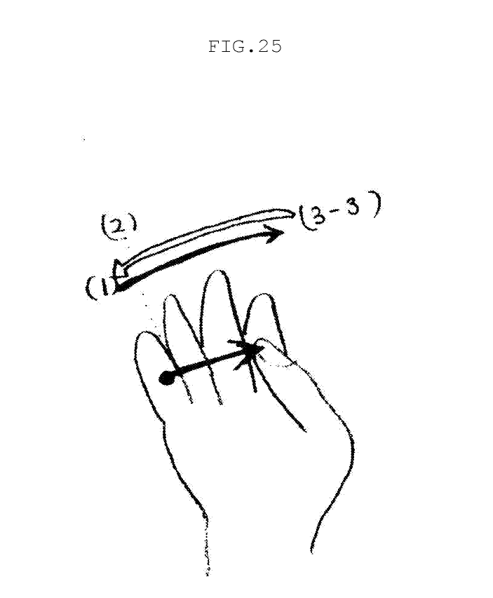

As illustrated in FIG. 23, a living body state of a hand and fingers (for example, a finger skeleton, a finger contact state, or the like) is recognized in the present embodiment. Then, as illustrated in FIG. 24, a boundary line for the condition (2) is set between the ring finger and the little finger in the present embodiment. The conditions (3-3) include requirements that the thumb should be kept out of contact with the other fingers when the user moves the thumb toward the little finger beyond the boundary line as illustrated in FIGS. 23 and 24, and that the thumb should come into contact with the other fingers when the user moves the thumb from the little finger to the forefinger beyond the boundary line as illustrated in FIGS. 24 and 25. The setting of the required conditions for the manipulation determination such that a non-contact state be continued while a living body part is moving through a boundary from one side to the other side, and a contact state should be continued while the living body is moving back from the other side to the one side enables further reduction of wrong actions.

Here is the end of the general description of the embodiment of the invention. Hereinafter, more detailed description of a configuration and processing examples is provided for an example in which the aforementioned overviews of the embodiments are implemented in a computer.

[Configuration of manipulation determination apparatus 100]

To begin with, description is provided for a configuration of a manipulation determination apparatus 100 as an example of a computer according to the present embodiment. In the following description, mainly explained is an example in which a first area moving in conjunction with a motion of a hand, fingers, or the like of a user is displayed as an image (such as a two-dimensional image, a three-dimensional image, or a skeleton) on a display screen by using a motion sensor or the like, such as a KINECT sensor manufactured by Microsoft Corporation, a Real Sense 3D camera manufactured by Intel Corporation, a Leap sensor manufactured by Leap Motion, Inc. However, the present invention does not always need such a display of an image moving in conjunction with a motion of a hand, fingers, or the like of a user, and the display may be omitted. For example, in the case of Meta glasses manufactured by Meta Company or Google Glass manufactured by Google Inc., the user can see his/her own real image directly or through the glass, and therefore it is unnecessary to display an image moving in conjunction with the hand, fingers, or the like of the user. Similarly, the following example is described based on the premise that a representative point of a boundary line is displayed. However, if there is a point, a line, or a plane recognizable by the user in the real space (for example, a frame of a display screen, a frame of a glass, a ring of a watch, a joint of a body (a joint of an elbow, a knee, a finger or the like)), a boundary line, a boundary plane, a representative point of the boundary line or plane, or the like does not always have to be displayed but may be hidden. In other words, such display is unnecessary and there is no need to provide any display means for that purpose, if the user can recognize a positional relation between his/her own body and a boundary (a boundary between a manipulable range and a non-manipulable range) in a real space, and a computer can determine the positional relation by means of a 3D camera, a motion sensor, or the like. In the following embodiment, a motion of a hand or fingers and a contact action of fingertips are explained mainly. However, the embodiment may be applied similarly to a motion of an eyeball and a contact action of an eyelid by using a publicly-known gaze point detection unit, a publicly-known eyelid opening/closing detection unit, or the like. For example, a rectangle may be displayed as a boundary line on a screen, and a manipulation of an element corresponding to the rectangle may be determined when the point of gaze of a user enters the inside of the rectangle (1), and the user closes one eye (2).

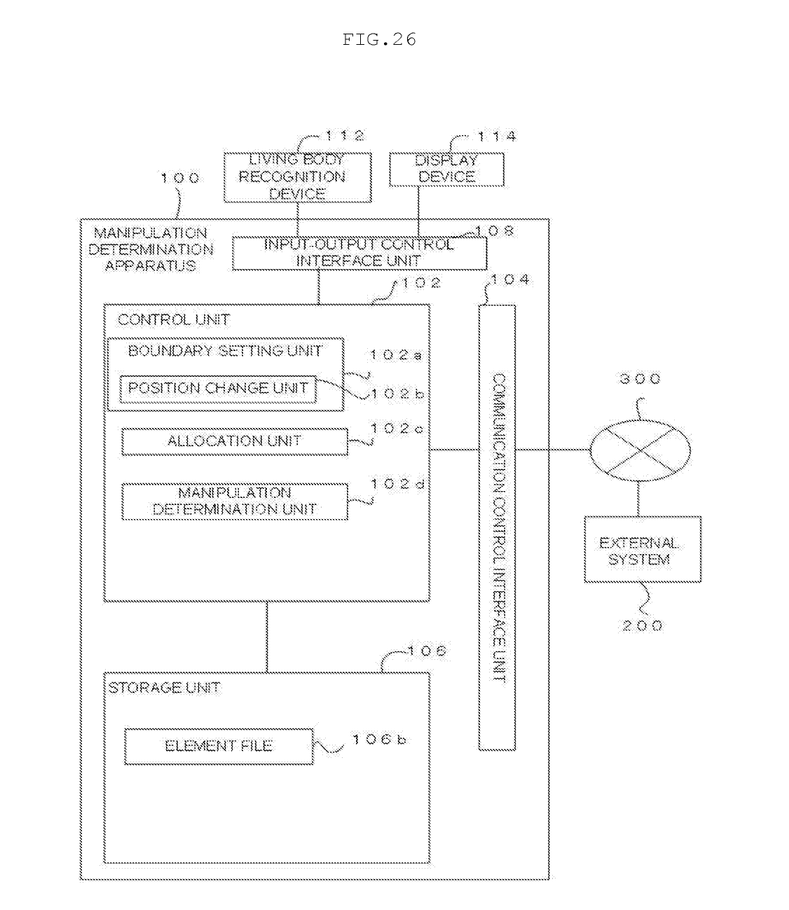

Here, FIG. 26 is a block diagram illustrating an example of the configuration of the manipulation determination apparatus 100 to which the present embodiment is applied, and conceptually illustrates only parts in the configuration related to the present embodiment.

As illustrated in FIG. 26, the manipulation determination apparatus 100 mainly includes a control unit 102, a communication control interface unit 104, an input-output control interface unit 108, and a storage unit 106. The control unit 102 is a CPU or the like that centrally performs overall control of the manipulation determination apparatus 100. The communication control interface unit 104 is connected to a communication device (not illustrated) such as a router connected to a communication line or the like. The input-output control interface unit 108 is connected to a living body recognition device 112, a display device 114 and the like. The storage unit 106 stores various kinds of databases and tables. These units are communicatively connected to each other via certain communication channels. As an example, the manipulation determination apparatus 100 may be a computer such as a smartphone, a tablet, or a notebook personal computer, and any of these computers may be configured as a head mount display (HMD) to be attached to a head. For example, it is possible to use a member with which a smartphone or tablet is fixed to a head, such as Google Cardboard manufactured by Google Inc., a hacosco, or Gear VR manufactured by Samsung Electronics Co., Ltd. In the case of the manipulation determination apparatus 100 configured as an HMD equipped with a three-dimensional camera, a Venue 8 tablet manufactured by Dell Inc. and equipped with a Real Sense 3D camera manufactured by Intel Corporation, as one example, may be fixed in front of a face by using members (a lens, a head band and the like) for attaching the HMD to the head. Instead, FOVE manufactured by FOVE, Inc. may be used as an HMD capable of detecting a motion of an eyeball or a point of gaze.

The various kinds of databases and tables (element file 106a and the like) stored in the storage unit 106 are storage units, such as a fixed disk device, that store various kinds of problems, tables, files, databases, web pages and the like to be used in various kinds of processing.

Among these constituent elements of the storage unit 106, the element file 106a is a data storage that stores data. The element file 106a stores data displayable as display elements on a display screen in one example. For instance, the element file 106a may store data to represent the second areas like icons, game characters, letters, symbols, figures, three-dimensional objects, and objects such as a virtual keyboard. In addition, the element file 106a may be associated with a program and the like so that a predetermined operation (display of a link destination, a key manipulation, display of a menu, power-on/off, channel change, mute, timer recording, or the like) can be performed when a manipulation such as a click is performed. The data format of the data to be displayed as these display elements may be any data format, which is not limited to image data, letter data, or the like. Moreover, a result of a manipulation determination by later-described processing of the control unit 102 may be reflected to the element file 160a. For example, every time (2) a nipping action is performed (1) beyond a surface (boundary plane) of a virtual keyboard in the element file 106a, a letter, symbol, or number corresponding to the key position of the virtual keyboard is stored in the element file 106a, so that a letter string or the like may be formed. In addition, when a manipulation target object A (or its element image) in the element file 106a is determined as being manipulated, the element file 106a may change data related to the object A from (for example, a function-off mode) to 1 (for example, a function-on mode) under the control of the control unit 102 and then store the resultant data. In one example, the element file 106a may store data for displaying web pages in a markup language such as html. In this data, manipulable elements are, for example, link indicating parts in the web pages. In general data in the HTML language, such a link indicating part is a text part, an image part or the like put between a start tag and an end tag, and this part is highlighted (for example, underlined) as a selectable (clickable) area on the display screen. In one example of the present embodiment, a GUI button surface may be set as a boundary plane, or the underline of a link may be set as a boundary line. Alternatively, in place of a clickable boundary line or boundary plane, an element image (such as a point) of a representative point or the like of the boundary line or plane may be displayed. For example, if a selectable area on the usual GUI is a rectangular area from the lower left coordinates (X1, Y1) to the upper right coordinates (X2, Y2) on the display screen, a later-described boundary setting unit 102a may set an initial position of a representative point of the boundary line to the center point ((X1+X2)/2, (Y1+Y2)/2) of the rectangular area, or to the upper right point (X2, Y2) of the rectangular area. In another example, the boundary setting unit 102a may set the boundary line to a line segment from (X1, Y1) to (X2, Y1) (such as the underline of the link indicating part).

In addition, in FIG. 26, the input-output control interface unit 108 controls the living body recognition device 112 such as a motion sensor, a 3D camera, and an ocular potential sensor, and the display device 114. For example, the display device 114 is a display unit such as a liquid crystal panel or an organic EL panel. Here, the manipulation determination apparatus 100 may include a sound output unit such as a speaker which is not illustrated, and the input-output control interface unit 108 may control the sound output unit. Although the following embodiment is mainly described on the assumption that the display device 114 is a monitor (including a home television or the like), the present invention is not limited to this case.

Moreover, the living body recognition device 112 is an image capture unit such as a 2D camera, or a living body recognition unit that detects a state of a living body, such as a motion sensor, a 3D camera, or an ocular potential sensor. For example, the living body recognition device 112 may also be a detection unit such as a CMOS sensor or a CCD sensor. Here, the living body recognition device 112 may be a photo detection unit that detects light with a predetermined frequency (infrared light). Use of an infrared camera as the living body recognition device 112 allows easy determination of the area of a person (heat-producing area) in an image, and thus enables, for example, only a hand area to be determined by using a temperature distribution of the person or the like. Besides, an ultrasonic or electromagnetic wave distance measurement device (such as a depth detection unit), a proximity sensor or the like can be used as the living body recognition device 112. For example, a combination of a depth detection unit and an image capture unit may be used to make determination on an image of an object (for example, an image of a person) located at a predetermined distance (depth), only. Alternatively, a publicly-known sensor, area determination technique, and control unit such as Kinect (trademark) can be used as the living body recognition device 112. Moreover, in addition to sensing of bio-information (skin color, temperature, infrared, and the like) of a person, the living body recognition device 112 may also function as a position detection unit configured to detect a motion of the person in place of the image capture unit, and thus may detect the position of a light source or the like held by a hand of a user or attached to an arm or any other part of the user. The living body recognition device 112 may use a publicly-known object tracking or image recognition technique to detect a contact/non-contact state of the living body, such as whether an eyelid, a mouth, or a palm is closed or opened. Then, the living body recognition device 112 may not only capture a two-dimensional image but also acquire a three-dimensional image by acquiring depth information with a TOF (Time of Flight) technique, an infrared pattern technique, or the like.

Any detection unit not limited to an image capture unit can be used to recognize a motion of a person, particularly, a motion of a hand of the person or a motion of a finger of the person. In this case, the detection unit may detect a motion of a hand by use of any publicly-known non-contact manipulation technique or any publicly-known image recognition technique. For example, an up-down or left-right motion of a suspended hand or a gesture may be recognized. The gesture can be derived from a user's position or motion in a physical space, and may include any user motion, dynamic or static, such as moving a finger or a static pose. In an embodiment, a capture device like a camera of the living body recognition device 112 is capable of capturing user image data, and the user image data includes data representing a user's gesture (one or more gestures). A computer environment may be used to recognize and analyze the gestures made by the user in the user's three-dimensional physical space such that the user's gestures may be interpreted to control aspects of a system or application space. This computer environment may display user feedback by mapping the user's gesture (one or more gestures) to an avatar or the like on a screen (see WO2011/084245). In one example, Leap Motion Controller (manufactured by Leap Motion, Inc) may be used as a publicly-known unit that recognizes hand or finger motions, or a combination of Kinect for Windows (registered trademark) (manufactured by Microsoft Corporation) and Windows (registered trademark) OS may be used as a unit capable of controlling without contact. Here, hand and finger skeleton information can be obtained by use of the Kinect sensor of Xbox One manufactured by Microsoft Corporation, or individual motions of all the fingers can be tracked by use of the LeapMotion sensor. In such processing, the hand or finger motion is analyzed by using a control unit incorporated in each sensor, or the hand or finger motion is analyzed by using a computer control unit connected to the sensor. Such control units may be considered as a functionally-conceptual detection unit in the present embodiment and considered as a functionally-conceptual control unit (for example, a manipulation determination unit 102d) in the present embodiment, or may be any or a combination of these units.

Here, description is provided for a positional relationship between the detection unit and the display unit, and their relationship with the display of the representation of a hand or finger of a person or the like. For the sake of description, a horizontal axis and a vertical axis of a plane of the display screen are referred to as an X axis and a Y axis, respectively, and a depth direction with respect to the display screen is referred to as a Z axis. In general, a user is located away from the display screen in the Z axis direction. The detection unit may be installed on a display screen side and directed toward the person, may be installed behind the person and directed toward the display screen, or may be installed below a hand suspended by the person (on a ground side) and directed to the hand of the person (toward a ceiling). As described above, the detection unit is not limited to an image capture unit that captures a two-dimensional image of a person, but may three-dimensionally detect the person. To be more specific, the detection unit may capture the three-dimensional figure of a person, and a later-described allocation unit 102c may convert the three-dimensional figure captured by the detection unit into a two-dimensional image and display the two-dimensional image on the display device 114. In this case, the allocation unit 102c may obtain a two-dimensional image in a XY plane, but does not have to take the three-dimensional figure along the XY plane strictly. For example, there is a case where two fingers (such as a thumb and a forefinger) of a person appear to touch each other when viewed in the Z axis direction from the display screen side, but the two fingers are apart from each other when viewed three-dimensionally. In this way, in some cases, the appearance (the shading) in the Z axis direction is different from a user's feeling of the fingers. For this reason, the allocation unit 102c may not necessarily display a strictly XY-planar projection of the figure. For example, the allocation unit 102c may obtain a two-dimensional image of the person's hand by cutting the three-dimensional figure thereof in a direction in which the two fingers appear to be apart from each other. Instead, the allocation unit 102c may display the XY-planar projection, while the manipulation determination unit 102d may judge if the two fingers are touching or apart from each other on the basis of the three-dimensional figure sensed by the detection unit, and perform control so as to agree with the user's feeling. Note that, when the fingers even look to touch each other in the appearance (the shading) in the z axis direction but are away from each other when viewed three-dimensionally, it is desirable the later-described manipulation determination unit 102d determine that the fingers are in the non-contact state in order to agree with the sense of touch by the user. Here, the detection of the contact/non-contact state is not limited to the detection by the image capture unit. Instead, the contact/non-contact state may also be detected by reading an electrical property such as a bioelectric current or static electricity of the living body.

In addition, in FIG. 26, the control unit 102 includes an internal memory that stores control programs such as an OS (Operating System), programs that specify various kinds of processing procedures, and required data. The control unit 102 performs information processing to implement various kinds of processing by using these programs and the like. In terms of functional concept, the control unit 102 includes a boundary setting unit 102a, a position change unit 102b, the allocation unit 102c and the manipulation determination unit 102d.

Among these units, the boundary setting unit 102a is a boundary setting unit that sets a manipulable boundary such that a user can recognize, for example, whether or not the user moves beyond a boundary line or boundary plane, or whether or not a representative point of a boundary line or a representative line segment of a boundary plane is put inside a closed ring formed by his/her own living body. As one example of the present embodiment, the boundary setting unit 102a controls display on the display device 114 such that the boundary line, the boundary plane or the like can be recognized, on the basis of the element data stored in the element file 102a. For example, the boundary setting unit 102a may set an underline of a link indicating part as a boundary, and perform control such that an element image of a representative point of the boundary line or the like (the element image is also referred to as a “point” hereinbelow) can be displayed while being associated with the link indicating part. Incidentally, the boundary setting unit 102a may initially hide such a point, and then display the point in a predetermined case (such as a case where a representation or an indicator is superimposed on a display element on the display screen). Here, as illustrated in FIG. 26, the boundary setting unit 102a in the present embodiment may include the position change unit 102b in order to improve manipulability. When the second area is moved under the second keeping-out movement control by the position change unit 102b, the boundary setting unit 102a may correspondingly change the boundary position from the initially-set position. Note that the element data does not always have to be read by controlling the element file 106a, but instead may be acquired by download from a storage unit (such as an element database) of an external system 200 via a network 300 or may be acquired through reception of broadcast airwaves or the like via a receiver device which is not illustrated. In this regard, the initial display position of the point associated with each element may be set to any position. In order that the correspondence between the point and the element can be recognized, a red dot or the like may be displayed as the point at a position such as the center of the displayed element (the center of a graphic representation as the element), or the right upper position of the displayed element (the upper right corner of a character string as the element). Instead, the boundary setting unit 102a may set, as the second area serving as the boundary, a character area manipulable with the outline of a hand, as in a game named Hoplites produced by Intel Corporation.

Then, the position change unit 102b is a change unit that performs processing such as the first keeping-out movement control and the second keeping-out movement control. For example, the position change unit 102b may perform the second keeping-out movement control of changing the display position of a second image (an image such as selectable display element or element image representing a second area) such that the second image can be driven out of a first image (an image such as a representation or indicator representing a first area) displayed by the allocation unit 102c. For example, suppose a case where under the control of the allocation unit 102c, the first image (representation or indicator) approaches the second image (display element, point or the like), and then the outline of the first image comes into contact with the outline of the second image. In this case, under the control of the position change unit 102b, the second image moves in conjunction with the first image while being kept in contact with the outline of the first image, unless the first image turns around and moves away from the second image. In one example of the present embodiment, the position change unit 102b performs control such that the representation or indicator displayed on the display screen by the allocation unit 102c can move the display element or point to a position out of the representation or indicator. Here, the position change unit 102b may limit a direction, range and the like where the second image (a point such as a display element or a representative point, a boundary line or the like) can be moved. In addition, the position change unit 102b may be disabled from performing the movement control unless the living body recognition device 112 or the like detects a contact action. Moreover, the position change unit 102b may preferentially perform control such that the second image (such as a display element or point) moves so as to be driven out of the first image (such as a representation or indicator), and otherwise move the display element or point to a predetermined position or in a predetermined direction. Specifically, the position change unit 102b may perform the control, as a preferential condition, to exclude the display element or point from the representation or indicator, and may move, as a subordinated condition, the display element or point to the predetermined position or in the predetermined direction. For example, when the display element (or point) is out of contact with the representation (or indicator), the position change unit 102b may return the display element (or point) to the initial display position before the movement. In another example, when the display element (or point) is not located near the representation (or indicator), the position change unit 102h may move the display element (or point) in a downward direction on the screen so that the user can feel as if the gravity were acting on the display element (or point). For convenience of explanation, the following description is provided in some part by explaining a display element or point as a representative of the display element and point, and a representation or indicator as a representative of the representation and indicator. However, the description should not be interpreted by being limited to only one of the display element and the point or only one of the representation and the indicator. For example, a part mentioned below as a display element may be read and applied as a point, and a part mentioned below as a representation can be read and applied as an indicator. On the other way round, a part mentioned below as a point may be read and applied as a display element, and a part mentioned below as an indicator may be read and applied as a representation.

Moreover, in a case where a first area comes close to or into contact with a second area or a similar case, the position change unit 102b may perform the first keeping-out movement control to change a motion of the first area in conjunction with a living body so as to make it harder for the whole or a part of the first area to move through the second area. For example, in the case where the first area comes close to or into contact with the second area or a similar case, the position change unit 102b may generate a time lag, decrease the speed, or make smaller a motion pitch of the first area moving in conjunction with the motion of the living body such that the motion of the first area in conjunction with the living body may be delayed so as to make it harder for the first area to move through the second area. More specifically, in the case where the first area moving in conjunction with the motion of the living body comes into contact with the second area, the position change unit 102b may stop the first area from moving for a predetermined period of time while keeping the contact state. Note that, irrespective of a change in the movement amount of the first area under the first keeping-out movement control by the position change unit 102b, the area allocation unit 102c can change the figure of the first area per se. More specifically, even if the movement of the first area is stopped, the figure of the first area (such as a three-dimensional hand area) can be changed on a three-dimensional computer space with the first area kept in contact with the second area (such as a line segment) such that the line segment can be intuitively and easily grabbed with the hand.

Here, the position change unit 102b may perform the second keeping-out movement control together with the first keeping-out movement control. Specifically, while performing the first movement control of changing the motion of the first area, the position change unit 102b may perform the second keeping-out movement control, thereby making the motions of the first area and the second area interact with each other. In this case, an execution ratio between the first keeping-out movement control and the second keeping-out movement movement control, or more specifically a ratio between a movement amount of the first area relatively moved contrary to the motion of the living body under the first keeping-out movement control, and a movement amount of the second area moved to avoid the first area under the second keeping-out movement control may be set as needed. The first keeping-out movement control and the second keeping-out movement control implemented by the position change unit 102b similarly prevent the first area that moves in conjunction with the living body from moving through the second area, and thereby contribute to the improvement in the manipulability.

Here, there are various modes of how the display element moves to keep out of a representation. For example, the position change unit 102b may cause a representative point (center point, barycenter or the like) of a display element to move so as to be driven out by the outline of the representation. Instead, the position change unit 102b may cause the outline of the display element to move so as to be driven out by the outline of the representation. Alternatively, the display element change unit 102b may cause the outline of the display element to move so as to be driven out by a representative line (center line or the like) of the representation or a representative point (barycenter, center point or the like) of the representation. Moreover, the control for such driving-out movement is not limited to a mode where the display element and the representation are kept in a contact state, but the display element change unit 102b may cause the display element to move so as to recede from the representation while keeping the display element in a non-contact state as if S poles of magnets repulse each other. In sum, as the first keeping-out movement control or the second keeping-out movement control, there are cases where: the area concerned is moved while the surfaces of the first and second areas are kept in contact with each other; the area is moved while the first and second areas overlap with each other to a certain degree; and the area is moved while the areas are kept at a certain distance from each other (like the south poles of magnets), and the position change unit 102b may perform the keeping-out movement control in any of the above cases.

In addition, in an exceptional example where a display element moves to keep out of a representation, the display element may be moved so as to traverse the representation. For instance, in the case where the representative point of the display element is not located near an inflection point of the outline of the representation, the position change unit 102b may cause the display element to move to traverse through the representation. More specifically, in the case where movement control is performed as if a tensile force were applied between the display element and the initial position, the display element, unless located between fingers or at abase of fingers, may be moved so as to traverse the representation of a hand and be returned to the initial position when the tensile force reaches a predetermined level or above. In addition, when the representative point of the display element falls into a local minimum of the outline line of the representation, the position change unit 102b may perform control to allow the display element to traverse the representation (such as a hand area) unless the representative point of the display element is located at a tangent point or an inflection point of the curve. Further, the position change unit 102b may allow the first area to move through the second area when restoring the first area from the first keeping-out movement control to the normal motion in conjunction with the living body.

Next, the allocation unit 102c is an allocation unit that allocates a two-dimensional or three-dimensional representation of a person whose image is captured with the living body recognition device 112 (or allocates an indicator that moves in conduction with a motion of the person) onto a computer space. In the present embodiment, the allocation unit 102c may cause the display device 114 to display the allocated two-dimensional representation or three representation image of the person as a first image. By the allocation unit 102c, a continuous change in the position or area corresponding to a motion of the body detected with the living body recognition device 112 is reflected on the computer space, and the position or area is moved in conjunction with the motion of the user. Here, the computer space may be one-dimensional, two-dimensional, or three-dimensional. Even in the case where the computer space is three-dimensional, a two-dimensional representation of a person, a boundary line, a boundary plane, a representative point of the boundary line, or a representative line segment of the boundary plane may be allocated on the three-dimensional coordinates. Note that the boundary line or boundary plane is not limited to a line or plane fixedly set in advance on the computer space. For example, the allocation unit 102c may extract, together with an image of a person, a certain thing which is image-captured together with the person with the living body recognition device 112 and which can serve as a basis for the boundary line or boundary plane (such as a joint of the skeleton of the user, glasses or a watch worn by the user, or a display frame of a display screen viewed by the user), and allocate the representation of the person and the boundary line or boundary plane onto the computer space. For example, the allocation unit 102c may set the boundary line or boundary plane based on the detected body of the user. For example, the boundary line or boundary plane may be set to the body axis at the backbone if the right hand is used for a manipulation, the boundary plane may be set based on the ring of the watch, or the boundary line may be set based on the rims of the glasses.

Here, the allocation unit 102c may display a mirror image of a user on the display screen as if the screen were a mirror when viewed from the user. For example, by the allocation unit 102c, a representation of a person whose image is captured with the living body recognition device 112 directed toward the person from the display screen of the display device 114 may be displayed as a left-right reversed representation on the display screen. Instead, if the living body recognition device 112 is installed to face the display screen of the display device 114 from behind the person, there is no need to reverse the representation in the left-right direction. Such mirror image display of the representation by the allocation unit 102c makes it easier for the user (person) to manipulate his/her own representation in such a way as to change the position of his/her own reflection in a mirror. In other words, the user is enabled to control the representation (or the indicator that moves in conjunction with the motion of the person) on the display screen in such away as to move his/her own silhouette. Thus, such display contributes to the improvement in manipulability. Incidentally, the allocation unit 102c may display only the outline line of the representation of the person, or may display the outline line of the indicator. Specifically, the area of the representation of the person is left unfilled, so that the inside of the outline can be made transparent and the display element inside the outline can be displayed. This produces an effect of offering superior visibility. In the way described above, the representation or indicator displayed on the display device 114 may be displayed as a mirror image.

Here, the allocation unit 102c may display a representation of an arm, a hand or fingers of a person whose image is captured with the living body recognition device 112 on the display screen of the display device 112. In this case, the allocation unit 102c may distinguish the area of the arm, the hand, the fingers or the like from the captured image of the person by using the infrared region, skin color or the like, and cut out and display only the distinguished area of the arm, the hand, the fingers or the like. Instead, the allocation unit 102c may determine the area of the arm, the hand, the fingers or the like by using any publicly-known area determination method.

Moreover, the allocation unit 102c may display on the screen an indicator (such as a polygon or a picture of a tool or the like) that moves in conjunction with the motion of the arm, the hand or the fingers of the person. Here, the allocation unit 102c may display the indicator corresponding to the position of the area of the arm, the hand, the fingers or the like determined as described above, or instead may detect the position of the arm, the hand, or the fingers in another method and display the indicator corresponding to the position thus detected. In an example of the latter case, the allocation unit 102c may detect the position of a light source attached to an arm by way of the image capture device 114, and display the indicator such that the indicator can move in conjunction with the detected position. Alternatively, the allocation unit 102c may detect the position of a light source held by a hand of the user and display the indicator such that the indicator can move in conjunction with the detected position. Here, the allocation unit 102c may allow a user to select a kind of indicator (one of kinds of graphic tools to be displayed as the indicator, including: pictures illustrating tools such as scissors, an awl, a stapler and a hammer; polygons; and the like) by using an input unit not illustrated, or the representation of the hand. This allows the user to select a graphic tool easy to manipulate and use the selected graphic tool to make element selection, even in the case where it is quite difficult for the user to perform manipulation using his/her own representation. Instead, for example, the allocation unit 102c may display five indicators (second areas such as precise circles or spheres) that move respectively in conjunction with the positions of the five fingertips (each being a part from the first joint to the distal end) of a hand. Here, the present embodiment may be implemented in such a way that the wording of “display” by the allocation unit 102c is replaced with “hide”, or the wording of “hide” by the allocation unit 102c is replaced with “display”.

Subsequently, the manipulation determination unit 102d is a manipulation determination unit that makes a manipulation determination when the first area and the second area come to have a predetermined relation. For example, the manipulation determination unit 102d may make a manipulation determination based on the required conditions: (1) a whole or part of the area of a person allocated by the allocation unit 102c enters a manipulable range beyond a border such as the boundary plane or boundary line; and (2) the living body recognition device 112 or the like detects the person performing a contact action or non-contact action of parts of his/her living body. Only when both the conditions (1) and (2) are met together, the manipulation determination unit 102d determines the action as having an intension to perform a manipulation, and executes the manipulation. In the determination of a contact action (2) for a second image (such as an element image or point) which is touched and moved by a first image, that the manipulation determination unit 102d may judge that the element is selected when the first image performs a predetermined action (for example, such as an action of closing the opened hand, or brining two fingers in a non-contact state into contact with each other). For instance, on the basis of a change in the three-dimensional figure of a hand of a person sensed by the detection unit, the manipulation determination unit 102d may determine whether the palm is opened or closed or determine whether the two fingers, namely, the thumb and the forefinger are away from or touch each other. Then, when determining that the predetermined action is done, the manipulation determination unit 102d may determine that the condition (2) is met.

Here, in addition to the foregoing conditions (1) and (2), the manipulation determination unit 102d may further add required conditions (3) in order to further reduce wrong actions. For example, the manipulation determination unit 102d may employ a required condition (3-1) that a contact action or a non-contact action is performed in a state where a whole or part of the allocated position or area is placed on a side of a boundary plane or boundary line on a computer space after passing through the boundary plane or line, is placed inside the boundary, or is crossing the boundary. Note that any of the two sides divided by a boundary plane or boundary line may be selected and set as a manipulable range (such as the inside of the boundary) as needed. Usually, if a side to which a user is less likely to come close while moving naturally is set as manipulation target range (such as the inside of the boundary), the user is less likely to perform a wrong action. Alternatively, the manipulation determination unit 102d may employ a required condition (3-2) that the living body moves toward the outside of a boundary after performing a contact action or a non-contact action inside the boundary. Besides, the manipulation determination unit 102d may employ a required condition (3-3) that a contact state established by a contact action or a non-contact state established by a non-contact action is continued while a whole or part of the allocated position or area is passing through a boundary plane or boundary line on a computer space. In another case, the manipulation determination unit 102d may employ required conditions (3-3) that a non-contact state is continued while a whole or part of the allocated position or area is moving through a boundary plane or boundary line from one side to the other side on a computer space, and a contact state is continued while a whole or part of the position or area is moving back from the other side to the one side.

In an example of the present embodiment, the manipulation determination unit 102d may determine a trigger for a manipulation of selecting the element based on a state (a moved state such as a movement degree or a post-movement position, an action, or the like) of the second image moved by the position change unit 102b of the boundary setting unit 102a while the foregoing conditions (1) and (2) are met. For example, in the case where the display element (or point) reaches a predetermined position or stays at a predetermined position, the manipulation determination unit 102d may judge that the display element is selected. In another example, the movement degree may be a moving distance or a time period that passes after a movement from the initial position. For instance, in the case where the display element (or point) is moved by a predetermined distance, the manipulation determination unit 102d may judge that the element is selected. Instead, in the case where a predetermined time period has passed after the display element (or point) was moved from the initial display position, the manipulation determination unit 102d may judge that the element is selected. To be more specific, in the case where the display element (or point) is returned to the initial position as the subordinated condition under the movement control of the position change unit 102b, the manipulation determination unit 102d may judge that the element is selected if the predetermined time period has already passed after the display element (or point) was moved from the initial display position. Incidentally, if a point is an object to be moved, the manipulation determination unit 102d judges that the element associated with the point is selected.

Here, such selection judgment is manipulation equivalent to an event such, for example, as a click in a mouse manipulation, an ENTER key press in a keyboard manipulation or a target touch manipulation in a touch panel manipulation. In one example, in the case where the selectable element associated with the second image is a link destination, the manipulation determination unit 102d performs control to transition the current display to the display of the link destination if judging that the element is selected. Besides, the manipulation determination unit 102d may judge an action of the user by using a publicly-known action recognition unit, a publicly-known motion recognition function or the like, which is used to recognize the motion of a person sensed by the aforementioned Kinect sensor or LeapMotion sensor.

Next, in FIG. 26, the communication control interface unit 104 is a device that controls communications between the manipulation determination apparatus 100 and the network 300 (or a communication device such as a router) and controls communications between the manipulation determination apparatus 100 and the receiver device not illustrated. In other words, the communication control interface unit 104 has a function to communicate data with other terminals or stations via communication lines (indifferent to wired or wireless lines). In addition, here, the receiver device is a reception unit that receives radio waves and the like from broadcast stations or the like, and is, for example, an antenna or the like.

To put it differently, the manipulation determination apparatus 100 may be communicatively connected via the network 300 to the external system 200 that provides an external database for the image data, external programs such as a program according to the present invention, and the like, or may be communicatively connected via the receiver device to the broadcast stations or the like that transmit the image data and the like. Further, the manipulation determination apparatus 100 may also be communicatively connected to the network 300 via a communication device such as a router and a wired or wireless communication line such as a dedicated line.

Here, in FIG. 26, the network 300 has a function to connect the manipulation determination apparatus 100 and the external system 200 to each other, and is for example the Internet or the like.

Then, in FIG. 26, the external system 200 is mutually connected to the manipulation determination apparatus 100 via the network 300 and has a function to provide the user with the external database for the image data and web sites that allow execution of the external programs such as the program.

Here, the external system 200 may be configured as a WEB server, an ASP server or the like, and may have a hardware configuration including a commercially-available general information processing apparatus such as a workstation or personal computer, and its auxiliary equipment. Then, functions of the external system 200 are implemented by a CPU, a disk device, a memory device, an input device, an output device, a communication control device and the like in the hardware configuration of the external system 200, control programs of these devices, and the like.

### Processing Example

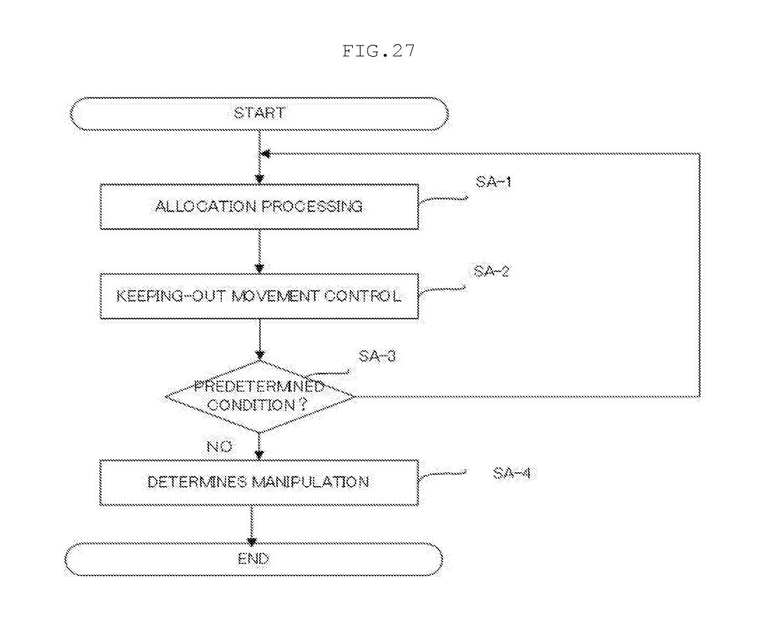

Next, one example of display information processing of the manipulation determination apparatus 100 configured as described above in the present embodiment is described below in detail with reference to FIG. 27. FIG. 27 is a flowchart illustrating one example of the display information processing of the manipulation determination apparatus 100 in the present embodiment.

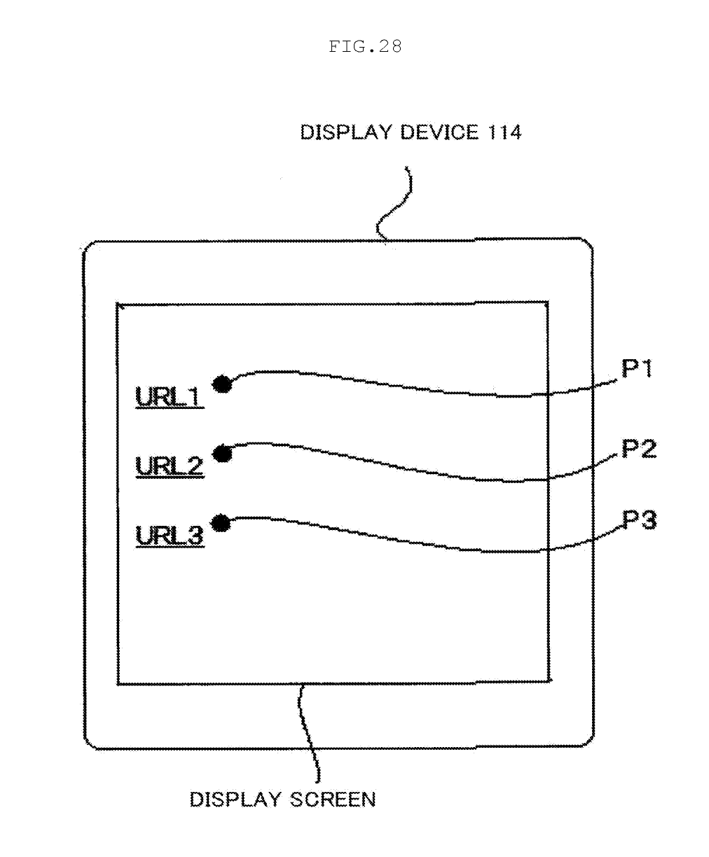

Note that the following processing is started on the premise that a certain type of display element is displayed on the display device 114 under the control of the boundary setting unit 102a. In this connection, FIG. 28 is a diagram illustrating an example of an external view of the display device 114 having the display screen displayed under the control of the control unit 102 such as the boundary setting unit 102a. As illustrated in FIG. 28, the manipulation determination apparatus 100 includes the display device 114 having the display screen depicted as a rectangular area. In this example, as illustrated in FIG. 28, the boundary setting unit 102a displays link indications and selectable elements in association with each other on the display screen, i.e., displays solid black circle points as the representative point of the boundary line above and to the left of the linkable letter strings. Specifically, a point P1 is associated with the link (www.aaa.bbb.ccc/) of a URL1, a point P2 is associated with the link (www.ddd.eee.fff/) of a URL2, and a point P3 is associated with the link (www.ggg.hhh.iii/) of a URL3. Then, programming is made such that selection of any of these elements will result in display of the associated link destination as similar to general web sites. Incidentally, although it is also possible to control display elements (link letter strings, icons or the like) such that the display elements themselves can move without displaying any points, the display information processing is herein explained by taking an example where the point positions are controlled. Here, these points do not have to be controlled movably if the first keeping-out movement control is performed. In the description of the present processing, however, illustrated is an example involving performing the keeping-out movement control of the points (second keeping-out movement control).

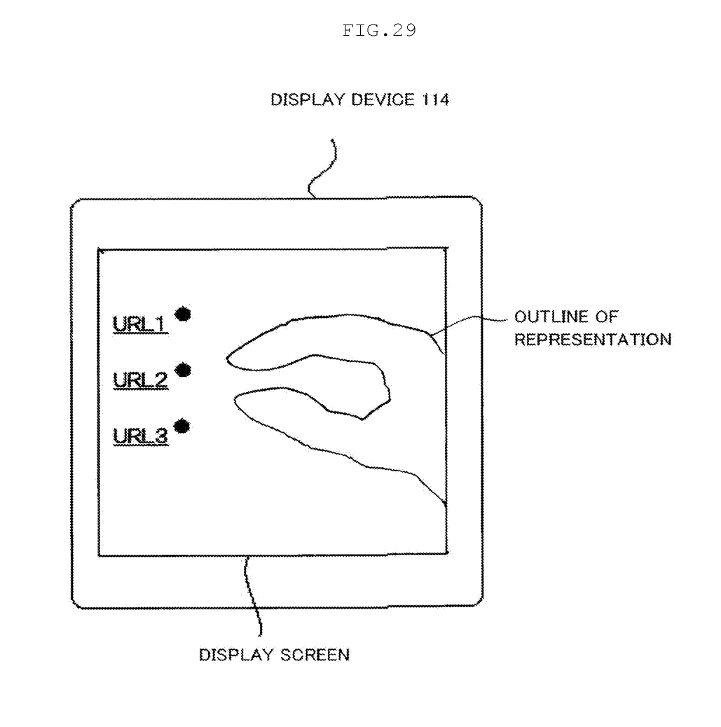

As presented in FIG. 27, the allocation unit 102c firstly allocates a first area such as a representation of a person whose image is captured with the living body recognition device 112 to the computer space, and causes the first area to be displayed as a first image on a screen of the display device 114 (step SA-1). For the sake of convenience of description, the computer space is herein handled as a plane, and the representation of the person and the points are described as those moving on the planar computer space. The computer space, however, is not limited to the plane. Instead, it is also possible to employ a three-dimensional computer space, to allocate a three-dimensional polygon or skeleton of a person, and to determine an action such as an action of passing through or crossing a boundary line, boundary plane or the like set on the three-dimensional coordinates, or an action of opening or closing a ring to encircle or release a reprehensive line segment of the boundary plane. Note that, in the case where the present embodiment is applied to AR like a transparent head-mounted display (such as smart glasses), a user can see his/her own fingers or the like as a real image, it is not necessary to display a first image corresponding to the first area if the first area can be handled on the computer space. In this step, the allocation unit 102c may display the representation on the display device 114 as if the user viewed his/her own mirror image. In this respect, FIG. 29 is a diagram illustrating one example of the display screen where the representation of the user is displayed in a superimposed manner on the initial screen of FIG. 28.

As illustrated in FIG. 29, from the entire image of a person captured with the living body recognition device 112, the allocation unit 102c may display only the representation of an arm, a hand or fingers on the display screen of the display device 112. For example, the allocation unit 102c may distinguish the area of the arm, the hand, the fingers or the like from the captured image of the person by means of a publicly-known area determination method using an infrared region, skin color or the like, and then cut out and display only the area of the arm, the hand, the fingers or the like. Alternatively, the allocation unit 102c may display only the outline line of the representation of the person and make the part inside the outline line of the representation transparent. Thus, the area of the representation of the person is left unfilled and the display elements inside the outline are presented. This way of display contributes to the improvements in manipulability and visibility. Instead, the allocation unit 102c may allocate the skeleton of the fingers to the computer space, and allocate five first areas (such as circles or spheres) to positions corresponding to the fingertips or first joints of the five fingers. Then, the later-described position change unit 102b may perform the first keeping-out movement control and/or the second keeping-out movement control on the five first areas corresponding to the respective fingers.

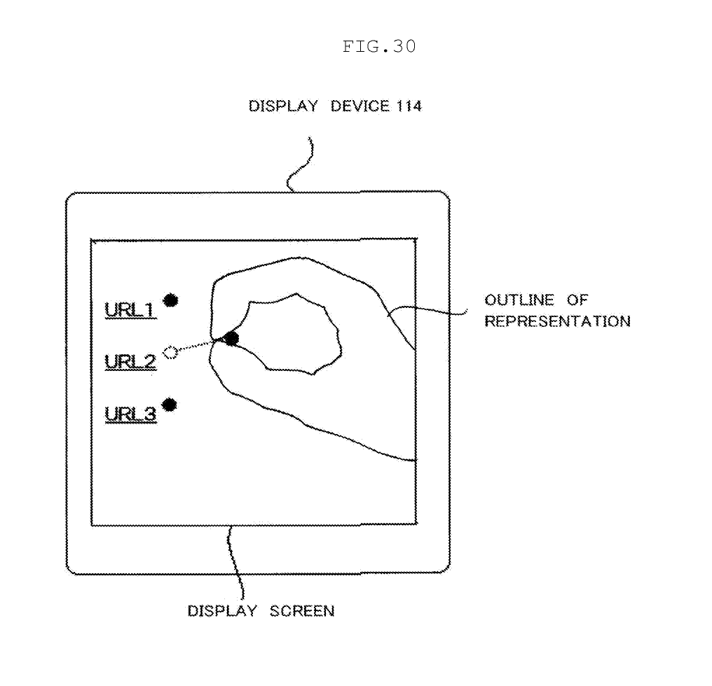

Here, the description is returned to FIG. 27, again. The position change unit 102b changes the display position of the point associated with a selectable element so that the point can be driven out of the representation displayed by the allocation unit 102c (step SA-2). Here, only when a contact action of the fingers is performed by the allocation unit 102c, the position change unit 102b may perform the movement control of the point. In this case, if the point (the representative point of the boundary line) is successfully moved, the required conditions (1) and (2) are met. On the other hand, when the contact action of the fingers is not performed by the allocation unit 102c, the position change unit 102b may perform the movement control of the point only within a predetermined distance, but may return the point to the initial position if the point is moved beyond the predetermined distance without execution of the contact action. Also in this case, if the point is nipped and moved, the condition (1) is met because the point is moved beyond a certain boundary line including the point. Then, in this state, if a contact action is performed (2), the later-described manipulation determination unit 102d may determine a manipulation. FIG. 30 is a display screen example illustrating one example of the point P2 whose display position is moved by the display position change unit 102b. In FIG. 30, a broken-line circle indicates the initial display position of the point P2, and a broken straight line indicates a distance d between the initial display position and the post-movement display position. Incidentally, the broken lines do not have to be displayed on the display screen.

As illustrated in FIG. 30, in order that the point can move to keep out of the representation, the position change unit 102b may cause the point to move so as to be driven out by the outline of the representation. Although the illustrated example is a movement control example where the outline of the point is driven out by the outline of the representation, the movement control is not limited to this. The position change unit 102b may perform movement control such that the outline of the point is driven out by a representative line (such as a center line) of the representation, or may cause the display element to move in the non-contact state so as to recede from the representation. Then, the position change unit 102b may also perform the first keeping-out movement control instead of or together with the second keeping-out movement control described above.

Here, the position change unit 102b may preferentially perform movement control such that the display element or point is driven out of the representation or indicator, and may also move the display element or point to the predetermined position or in the predetermined direction. For example, the position change unit 102b may move the point back to the initial display position before the movement if the point is out of contact with the representation.

The description is returned to FIG. 27, again. The manipulation determination unit 102d determines whether or not the predetermined conditions for the manipulation determination are met (step SA-3). For example, the manipulation determination unit 102d determines whether a whole or part of the area of the representation or indicator of the user passes through the boundary line (1), and whether or not the parts of the living body perform the contact action (step SA-3). In this example, the determination on the manipulation of selecting the element corresponding to the point is triggered when the condition (3) that a predetermined movement of the point is performed by the position change unit 102b is met in addition to these conditions (1) and (2) (step SA-3). For example, the manipulation determination unit 102d may judge that the element associated with the point P2 is selected (display of the link destination of URL2 is selected) in the case where the point 2 moves by a predetermined movement degree (a case where the movement degree reaches a predetermined threshold or above or the like case) such as cases where: the point P2 reaches a predetermined position; the moving distance d from the initial position reaches a predetermined threshold or above; and a certain time period passes after the start of movement from the initial position.

If the manipulation determination unit 102d determines that the predetermined conditions are not met (step SA-3, No), the manipulation determination apparatus 100 returns the processing to step SA-1, and performs control to repeat the foregoing processing. Specifically, the allocation unit 102c updates the display of the representation (step SA-1), subsequently the position change unit 102b performs the movement control of the display position (step SA-2), and then the manipulation determination unit 102d again judges the movement degree (step SA-3).

If determining that the predetermined conditions are met (step SA-3, Yes), the manipulation determination unit 102d determines that a manipulation of selecting the element corresponding to the point is done (step SA-4), and the control unit 102 of the manipulation determination apparatus 100 executes the processing of the selected manipulation (such as a click or scroll). For example, in the example in FIG. 30, if the condition (3) that a distance d between the initial position of the point P2 and the post-movement display position of the point P2 is equal to or longer than a predetermined threshold is met in addition to the conditions (1) and (2), the manipulation determination unit 102d may judge that the element (a link to URL2) associated with the point P2 is selected, and the manipulation determination apparatus 100 may cause display of the link destination of URL2 as the selected manipulation.

The foregoing description is provided as one example of the processing of the manipulation determination apparatus 100 in the present embodiment. It should be noted that, in the present embodiment, one manipulation point is set, but two manipulation points may be set instead of one manipulation point. Use of two manipulation points allows the direction of a bar or the orientation of a three-dimensional object to be changed by the left and right hands, or enables a manipulation of scaring-down/up or the like in a multitouch manipulation.

### [Processing Example of First Keeping-Out Movement Control]

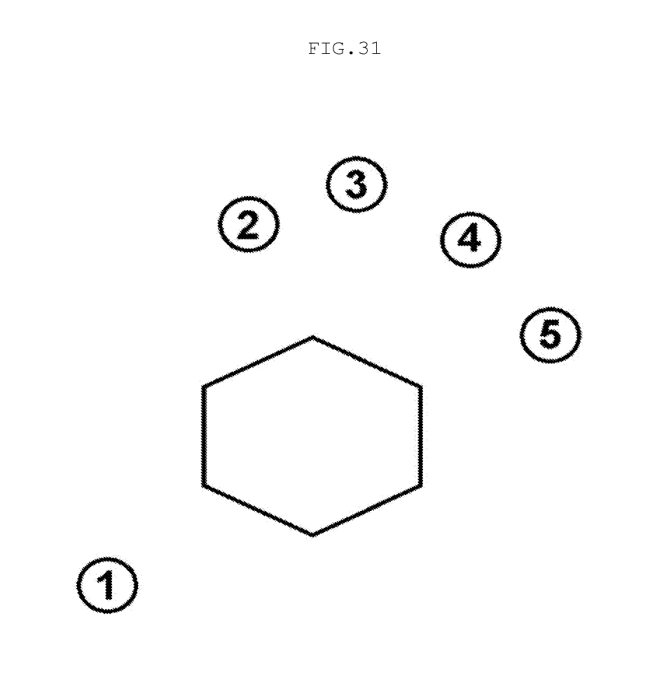

Although the foregoing processing example is described for the case where the second keeping-out movement control is performed, the first keeping-out movement control may also be performed. Here, FIGS. 31 to 34 are transition diagrams schematically illustrating a transition of first areas and a second area under the first keeping-out movement control. A hexagon in the drawings represents the second area, and circles in the drawings represent the first areas corresponding to the respective fingers. In addition, the numerals 1, 2, 3, 4, and 5 in the circles represent a first digit (thumb), a second digit (forefront finger), a third digit (middle finger), a fourth digit (ring finger), and a fifth digit (little finger), respectively.

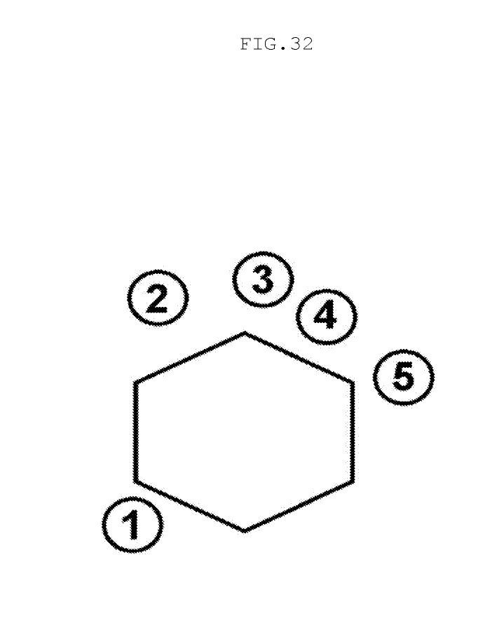

As illustrated in FIGS. 31 and 32, when a user is closing the opened hand toward the second area such as a button, the allocation unit 102c moves the five first areas 1 to 5 corresponding to the respective fingertips on the computer space in conjunction with the motions of the fingertips recognized by the living body recognition device 112.

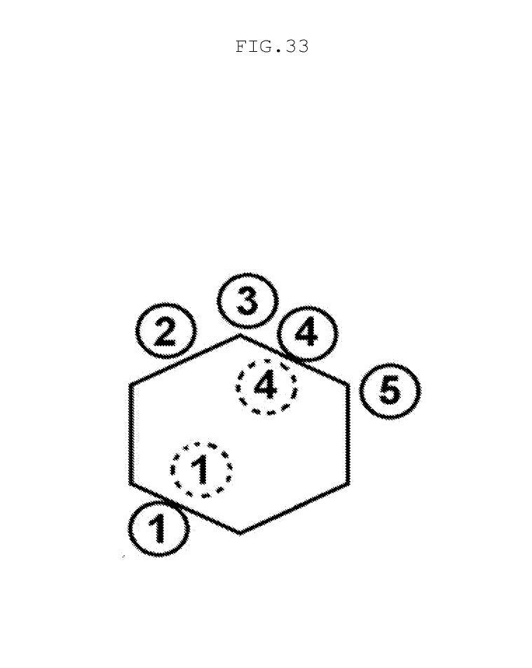

Then, as illustrated in FIGS. 32 and 33, when the user closes the palm so as to grab the button, the allocation unit 102c further moves the five first areas 1 to 5 in conjunction with the motions of the fingertips recognized by the living body recognition device 112, and allocates the first area 1 corresponding to the thumb and the first area 3 corresponding to the ring finger to the inside of the second area as illustrated by broken-line circles in FIG. 33. In this case, the position change unit 102b performs the movement control such that the first areas may not move over the second area. More specifically, as illustrated in FIG. 33, the position change unit 102h offsets the first area 1 depicted by the broken-line circle to the first area 1 depicted by the solid-line circle, and similarly offsets the first area 4 depicted by the broken-line circle to the first area 4 depicted by the solid-line circle.

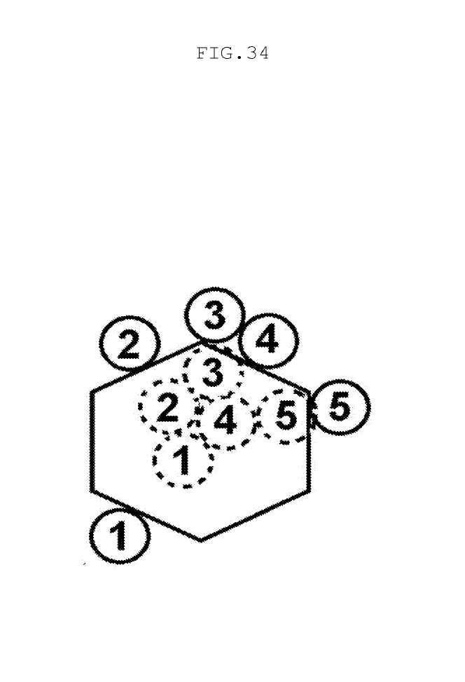

Further, as illustrated in FIGS. 33 and 34, when the user performs a nipping action by bringing the fingertips into contact with each other, the allocation unit 102c further moves the first areas 1 to 5 in conjunction with the motions of the fingertips recognized by the living body recognition device 112, and allocates the first areas 1 to 5 to first areas 1 to 5 depicted by broken-line circles in FIG. 34. At this time, in the same manner as the above, the position change unit 102b offsets the first areas 1 to 5 depicted by the broken-line circles to first areas 1 to 5 depicted by solid-line circles such that the first areas 1 to 5 can be located outside the second area, as illustrated in FIG. 34.

Note that the manipulation determination unit 102d may make a manipulation determination based on the real state of the living body recognized by the living body recognition device 112 irrespective of the states of the first areas offset under the first keeping-out movement control by the position change unit 102b. More specifically, based on the first areas originally allocated by the allocation unit 102c (the first areas 1 to 5 depicted by the broken-line circles in FIG. 34), the manipulation determination unit 102d may make the manipulation determination based on the conditions that (1) the fingertips are in contact with each other, and (2) the fingertips are moved beyond the boundary of the second area (the outline of the hexagon in this example). In this example, at the stage where a transition from FIGS. 33 to 34 occurs, the manipulation determination unit 102d can determine that the fingertips come into contact with each other (1) and are moved beyond the boundary of the second area (2), and thus a button manipulation can be executed.

In the foregoing example, assume that the first digit (thumb) enters the second area in the first place at the transition from FIGS. 32 to 33. At this time, only the first digit (thumb) is moved so as to come into contact with the second area in the foregoing example. However, the first keeping-out movement control is not limited to this example. Instead, the first keeping-out movement control may be performed while maintaining the positional relationship among the five fingers to the maximum extent possible. To be more specific, the first areas 2 to 5 of the other four fingers may be moved by the same movement amount as the movement amount by which the position (first area 1) of the first digit (thumb) is offset from its original position in a lower-left direction in the drawings. In this way, the first keeping-out movement control can be performed while maintaining the positional relationship among the multiple first areas. In addition, if the first area 1 corresponding to the first digit (thumb) comes into contact with the second area in the first place at the transition from FIGS. 32 to 33, the position change unit 102b may perform the second keeping-out movement control to move the second area (hexagon) in the direction opposite to the approaching thumb (in an upper-right direction in the drawings in this example). In this way, the movement control of the second area against the first area and the movement control of the first area against the second area each handle a relative relationship, and both produce substantially common effects. Then, any movement control amount ratio may be set as needed between a movement control amount of the second keeping-out movement control in which the second area is controlled to move so as to be driven out of the first area (for example, a movement amount of a button), and a movement control amount of the first keeping-out movement control in which the first area is controlled to move so as to be driven out of the second area (for example, an offset amount of a fingertip image), and these two kinds of keeping-out movement control may be performed in parallel. To be more specific, if the first area 1 corresponding to the first digit (thumb) comes into contact with the second area in the first place at the transition from FIGS. 32 to 33, the position change unit 102b may perform the second keeping-out movement control to move the second area (hexagon) in the direction opposite to the approaching thumb (in the upper-right direction in the drawings in this example).

Then, when the second area (hexagon) also comes into contact with the first area 4 corresponding to the fourth digit while moving so as to keep out of the first digit (thumb), the position change unit 102b may initiate the aforementioned first keeping-out movement control for the first time because the second area is sandwiched between the first digit and the fourth digit and is no longer movable to keep out of the digits (the second keeping-out movement control is no longer executable).

### Other Embodiments

The embodiments of the present invention have been described above. However, the present invention may be implemented by not only the embodiments described above but also various different embodiments within the technical idea described in the scope of claims.

For example, the above explanation is given of the case where the manipulation determination apparatus 100 performs the processing in stand-alone mode as an example; however, the manipulation determination apparatus 100 may perform the processing in response to a request from a client terminal (cabinet different from the manipulation determination apparatus 100) and return the processing results to the client terminal.

Moreover, among the processings described in the embodiment, all or part of the processings described as automatic processing may be performed manually and all or part of the processings described as manual processing may be performed automatically by known methods.

In addition thereto, the processing procedures, the control procedures, the specific names, the information including registered data of each processing and parameters, such as retrieval conditions, the screen examples, and the database configurations, described in the literature and drawings above may be arbitrarily modified unless otherwise indicated.

Furthermore, each component of the manipulation determination apparatus 100 illustrated in the drawings is formed on the basis of functional concept, and is not necessarily configured physically the same as those illustrated in the drawings.

For example, all or any part of the processing functions that the devices in the manipulation determination apparatus 100 have, and particularly each processing function performed by the control unit 102, may be implemented by a CPU (Central Processing Unit) and a program interpreted and executed by the CPU, or may be implemented as hardware by wired logic. The program, which includes programmed instructions that let a computer to execute a method according the present invention, is recorded in a non-transitory computer-readable storage medium and is mechanically read by the manipulation determination apparatus 100 as necessary. Specifically, the storage unit 106, such as a ROM and an HDD (Hard Disk Drive), or the like records a computer program for providing instructions to the CPU in cooperation with the OS (Operating system) and for executing various processings. This computer program may be executed by being loaded into a RAM and configure the control unit in cooperation with the CPU.

Moreover, this computer program may be stored in an application program server that is connected to the apparatus 100 via the network 300, and all or part thereof may be downloaded as necessary.

Furthermore, the program according to the present invention may be stored in a computer-readable recording medium, or may be configured as a program product. The “recording medium” includes any “portable physical medium”, such as a memory card, a USB memory, an SD card, a flexible disk, a magneto-optical disk, a ROM, an EPROM, an EEPROM, a CD-ROM, an MO, a DVD, and a Blue-ray™ Disc.

Moreover, the “program” refers to a data processing method written in any language and any description method and is not limited to a specific format, such as source codes and binary codes. The “program” is not necessarily configured unitarily and includes a program constituted in a dispersed manner as a plurality of modules and libraries and a program that implements its functions in cooperation with a different program representative of which is an OS (Operating System). Well-known configurations and procedures may be used for the specific configuration and reading procedure for reading a recording medium, the installation procedure after reading a recording medium, and the like in each device illustrated in the present embodiment. The program product in which the program is stored in a computer-readable recording medium may be configured as one aspect of the present invention.

Various databases and the like (the element file 106a) stored in the storage unit 106 are a storage unit, example of which is a memory device, such as a RAM and a ROM, a fixed disk drive, such as a hard disk, a flexible disk, and an optical disk, and stores various programs, tables, databases, files for web pages, and the like that are used for various processings or providing websites.

Moreover, the manipulation determination apparatus 100 may be configured as an information processing apparatus, such as known personal computer and workstation, or may be configured by connecting an arbitrary peripheral device to the information processing apparatus. Moreover, the manipulation determination apparatus 100 may be realized by installing software (including program, data, and the like) that causes the information processing apparatus to realize the method according to the present invention.

A specific form of distribution/integration of the devices is not limited to those illustrated in the drawings and it may be configured such that all or part thereof is functionally or physically distributed or integrated, by arbitrary units, depending on various additions or the like or depending on functional load. In other words, the above-described embodiments may be implemented by arbitrarily combining them, with each other or the embodiments may be selectively implemented.

Hereinafter, other examples of claims according to the present invention are listed.

### (Claim 1-1: Second Keeping-Out Movement Control)

An apparatus including a unit that recognizes a motion of a hand or finger; a unit that allocates a first area on a computer space, the first area moving in conjunction with the recognized motion of the hand or finger; a unit that allocates a second area corresponding to a selectable element and performs movement control such that the second area avoids the coming first area on the computer space; and a unit that judges that the selectable element corresponding to the second area is selected when a relation between the first area and the second area meets a predetermined condition.

### (Claim 1-2: First Keeping-Out Movement Control)

An apparatus including: a unit that recognizes a motion of a hand or finger; a unit that allocates a first area on a computer space, the first area moving in conjunction with the recognized motion of the hand or finger; a unit that allocates a second area corresponding to a selectable element and performs movement control such that the coming first area on the computer space is prevented from traversing the second area; and a unit that judges that the selectable element corresponding to the second area is selected when a relation between the first area and the second area meets a predetermined condition.

### (Claim 2-1: Second Keeping-Out Movement Control)

A manipulation determination apparatus including at least a detection unit and a control unit, wherein the control unit includes: an allocation unit that allocates a first area onto a computer space, the first area being an area of a person whose image is captured with the detection unit, or an area moving in conjunction with a motion of the person; a movement control unit that allocates a second area associated with a selectable element, and causes the second area to move so as to be driven out of the first area; and a selection judgment unit that judges that the element is selected based on a movement degree or a post-movement position of the element or the element image moved by the movement control unit.

### (Claim 2-2: First Keeping-Out Movement Control)

A manipulation determination apparatus including at least a detection unit and a control unit, wherein the control unit includes: an allocation unit that allocates a first area onto a computer space, the first area being an area of a person whose image is captured with the detection unit, or an area moving in conjunction with a motion of the person; a movement control unit that allocates a second area associated with a selectable element, and limits a movement of the first area to make it harder for the first area to traverse the second area; and a selection judgment unit that judges that the element is selected based on a movement degree or a post-movement position of the element or the element image moved by the movement control unit.

### (Claim 3)

An apparatus according to claim 1 or 2, wherein

the second area is displayed on a display unit in such a transparent or superimposed manner that a motion of the hand or finger or a motion of the person corresponding to the first area is recognizable.

### (Claim 4)

An apparatus according to any one of claims 1 to 3, wherein

the movement control unit preferentially performs control to cause the second area to move so as to be driven out of the first area, and otherwise moves the second area to a predetermined position or in a predetermined direction.

### (Claim 5)

An apparatus according to any one of claims 1 to 4, wherein the allocation unit allocates, onto the computer space, a representation of an arm, hand or finger of the person whose image is captured with the detection unit, or an area that moves in conjunction with a motion of the arm, hand or finger of the person.

### (Claim 6)

An apparatus according to any one of claims 1 to 5, wherein the movement control unit causes the element or an image of the element to move so as to be driven out of an outline or a center line of the first area.

### (Claim 7)

An apparatus according to any one of claims 1 to 6, wherein the movement degree is a moving distance or a time period that passes after a movement from an initial position.

### (Claim 8-1: Second Keeping-Out Movement Control)

A method causing a computer to execute the steps of: recognizing a motion of a hand or finger; allocating a first area on a computer space, the first area moving in conjunction with the recognized motion of the hand or finger; allocating a second area corresponding to a selectable element onto the computer space, and performing movement control to cause the second area to avoid the coming first area; and judging that the selectable element corresponding to the second area is selected when a relation between the first area and the second area meets a predetermined condition.

### (Claim 8-2: First Keeping-Out Movement Control)

A method causing a computer to execute the steps of: recognizing a motion of a hand or finger; allocating a first area on a computer space, the first area moving in conjunction with the recognized motion of the hand or finger; allocating a second area corresponding to a selectable element and limiting a movement of the first area such that the first area is prevented from traversing the second area; and judging that the selectable element corresponding to the second area is selected when a relation between the first area and the second area meets a predetermined condition.

### (Claim 9)

A method to be implemented by a computer including at least a detection unit and a control unit, wherein the control unit includes the steps of: allocating a first area onto a computer space, the first area being an area of a person whose image is captured with the detection unit, or an area moving in conjunction with a motion of the person; displaying a selectable element or a second area associated with the element on a screen of the display unit, and causing the second area to move so as to be driven out of the first area; and judging that the selectable element is selected based on a moving degree or a post-movement position of the moved second area or based on an action of the first area.

### (Claim 10-1: Second Keeping-Out Movement Control)

A program causing a computer to execute the steps of: recognizing a motion of a hand or finger; allocating a first area on a computer space, the first area moving in conjunction with the recognized motion of the hand or finger; allocating a second area corresponding to a selectable element onto the computer space, and performing movement control to cause the second area to avoid the coming first area; and judging that the selectable element corresponding to the second area is selected when a relation between the first area and the second area meets a predetermined condition.

### (Claim 8-2: First Keeping-Out Movement Control)

A program causing a computer to execute the steps of: recognizing a motion of a hand or finger; allocating a first area on a computer space, the first area moving in conjunction with the recognized motion of the hand or finger; allocating a second area corresponding to a selectable element and limiting a movement of the first area so as to prevent the first area from traversing the second area; and judging that the selectable element corresponding to the second area is selected when a relation between the first area and the second area meets a predetermined condition.

### (Claim 11)

A program to be executed by a computer including at least a detection unit and a control unit, wherein the control unit causes the computer to execute the steps of: allocating a first area onto a computer space, the first area being an area of a person whose image is captured with the detection unit, or an area moving in conjunction with a motion of the person; allocating a selectable element or a second area being an area associated with the element onto a screen of the display unit, and causing the second area to move so as to be driven out of the first area or limiting a movement of the first area so as to prevent the first area from traversing the second area; and judging that the selectable element corresponding to the second area is selected when the first area and the second area come to have a predetermined relation.

### (Claim 12)

A storage medium in which the program according to claim 11 or 12 is recorded in a manner readable by a computer.

### Claim 0

A manipulation determination apparatus including at least a display unit, an image capture unit and a control unit, wherein

the control unit includes

an element display control unit that displays a selectable element or an element image associated with the element on a screen of the display unit, and

a representation display control unit that displays, on the screen, a representation of a person whose image is captured with the image capture unit or an indicator that moves in conjunction with a motion of the person, and

the element display control unit includes a movement control unit that causes the element or the element image to move so as to be driven out of the representation or the indicator displayed by the representation display control unit, and

the control unit further includes a selection judgment unit that judges that the element is selected based on a movement degree or a post-movement position of the element or the element image moved by the movement control unit.

Claim 1

A manipulation determination apparatus including at least a display unit, an image capture unit and a control unit, wherein

the control unit includes:

a hand area display control unit that causes the image capture unit to capture an image of a user and displays a user area, which is at least a hand or finger area of the user, in a distinguishable manner on the display unit;

a display element movement unit that displays a selectable display element such that the selectable display element is moved so as to be driven out of the user area displayed by the hand area display control unit; and

a selection judgment unit that judges that the display element is selected based on a movement degree of the display element moved by the display element movement unit.

### Claim 2 (Display Element Movement Mode: Return to Initial Position)

The manipulation determination apparatus according to claim 1, wherein

the display element movement unit controls movement of the display element as if a force of returning the display element to an initial position were applied to the display element.

### Claim 3 (Display Element Movement Mode: Gravity)

The manipulation determination apparatus according to claim 1 or 2, wherein

the display element movement unit controls movement of the display element as if gravity in a downward direction of a screen were applied to the display element.

### Claim 4 (Display Element Movement Mode: Magnet)

The manipulation determination apparatus according to any one of claims 1 to 3, wherein

the display element movement unit controls movement of the display element as if attractive forces were applied between the user area and the display element.

### Claim 5 (Selection Judgment 1: Distance)

The manipulation determination apparatus according to any one of claims 1 to 4, wherein

the movement degree is a distance by which the display element is moved,

the selection judgment unit judges that the display element is selected when the display element is moved by a predetermined threshold distance or longer.

### Claim 6 (Selection Judgment 2: Time Period)

The manipulation determination apparatus according to any one of claims 1 to 5, wherein

the movement degree is a duration of movement of the display element, and

the selection judgment unit judges that the display element is selected when a predetermined threshold time period or longer passes after the start of the movement of the display element.

### Claim 7 (Exclusion: Representative Point of Display Element)

The manipulation determination apparatus according to any one of claims 1 to 6, wherein

the display element movement unit moves and displays the display element such that a representative point of the display element is driven out of the user area.

### Claim 8 (Display Element Movement Mode: Tensile Force)

The manipulation determination apparatus according to claim 2, wherein

the display element movement unit

controls movement of the display element as if a tensile force according to the movement degree were applied between an initial position and a post-movement position of a representative point of the display element, and

when the representative point of the display element falls into a local minimum of an outline line of the user area, performs control to allow the display element to traverse the user area unless the representative point of the display element is located at a tangent point of the curve.

### Claim 9

A program to be executed by an information processing apparatus including at least a display unit, an image capture unit and a control unit, the program causing the control unit to execute:

a hand area display controlling step of causing the image capture unit to capture an image of a user, and displaying at least a user area of the user in a distinguishable manner on the display unit;

a display element moving step of moving and displaying a selectable display element such that the selectable display element is driven out of the user area displayed in the hand area display controlling step; and

a selection judging step of judging that the display element is selected based on a movement degree of the display element moved in the display element moving step.

### Claim 10

A manipulation determination method to be implemented by a computer including at least a display unit, an image capture unit and a control unit, the method comprising the following steps to be executed by the control unit:

an element display controlling step of displaying a selectable element or an element image associated with the element on a screen of the display unit;

a representation display controlling step of displaying, on the screen, a representation of a person whose image is captured with the image capture unit or an indicator that moves in conjunction with a motion of the person;

a movement controlling step of causing the element or the element image to move so as to be driven out of the representation or the indicator displayed in the representation display controlling step; and

a selection judging step of judging that the element is selected based on a movement degree or a post-movement position of the element or the element image moved in the movement controlling step.

### Claim 11

A program to be executed by a computer including at least a display unit, an image capture unit and a control unit, the program causing the control unit to execute:

an element display controlling step of displaying a selectable element or an element image associated with the element on a screen of the display unit;

a representation display controlling step of displaying, on the screen, a representation of a person whose image is captured with the image capture unit or an indicator that moves in conjunction with a motion of the person;

a movement controlling step of causing the element or the element image to move so as to be driven out of the representation or the indicator displayed in the representation display controlling step; and

a selection judging step of judging that the element is selected based on a movement degree or a post-movement position of the element or the element image moved in the movement controlling step.

### INDUSTRIAL APPLICABILITY

As has been described in details above, the present invention enables provision of a manipulation determination apparatus, a manipulation determination method, a program, and a storage medium, which are capable of improving manipulability in performing a manipulation by moving a body.

### EXPLANATION OF REFERENCE NUMERALS

100 manipulation determination apparatus
102 control unit
102a boundary setting unit
102b position change unit
102c allocation unit
102d manipulation determination unit
104 communication control interface unit
106 storage unit
106a element file
108 input-output control interface unit
112 living body recognition device
114 display device
200 external system
300 network

1. A manipulation determination apparatus comprising:
a living body recognition unit that recognizes a state of a living body of a user;
an allocation unit that allocates a first area onto a computer space such that the first area moves in conjunction with the recognized state of the living body;
a change unit that changes a motion of the first area in conjunction with the living body so as to make it harder for the first area to move through a second area allocated on the computer space; and
a manipulation determination unit that determines that a manipulation corresponding to the second area is done when the first area and the second area come to have a predetermined relation.

2. A manipulation determination apparatus comprising:
a living body recognition unit that recognizes a state of a living body of a user;
an allocation unit that allocates a first area onto a computer space such that the first area moves in conjunction with the recognized state of the living body;
a change unit that moves a second area allocated on the computer space such that the second area keeps away from the coming first area; and
a manipulation determination unit that determines that a manipulation corresponding to the second area is done when the first area and the second area come to have a predetermined relation.

3. A manipulation determination apparatus comprising:
a living body recognition unit that recognizes a state of a living body of a user;
an allocation unit that allocates a position or area onto a computer space such that the position or area moves in conjunction with the recognized state of the living body; and
a manipulation determination unit that, when determining a manipulation corresponding to a motion of the living body, uses required conditions that a whole or part of the position or area passes through a boundary plane or boundary line on the computer space, and that parts of the living body perform a contact action or a non-contact action.

4. The manipulation determination apparatus according to claim 3, wherein
the living body is at least any one of the head, mouth, feet, legs, arms, hands, fingers, eyelids and eyeballs of the user.

5. The manipulation determination apparatus according to claim 3, wherein
the contact action by the parts of the living body is any one of an action of bringing at least two fingertips or finger pads into contact with each other, an action of joining and touching at least two fingers together, an action of closing a flat open hand, an action of laying down a thumb in a standing state, an action of bringing a hand or finger into contact with a part of the body, an action of bringing both hands or both feet into contact with each other, an action of closing the opened mouth, and an action of closing an eyelid.

6. The manipulation determination apparatus according to claim 3, wherein
the non-contact action by the parts of the living body is any one of an action in which at least two fingertips or finger pads in contact with each other are moved away from each other, an action in which two fingers whose lateral sides are in contact with each other are moved away from each other, an action of opening a closed hand, an action of raising up a thumb in a lying state, an action in which a hand or finger in contact with a part of the body is moved away from the part, an action in which both hands or both legs in contact with each other are moved away from each other, an action of opening the closed mouth, and an action of opening a closed eyelid.

7. The manipulation determination apparatus according to claim 3, wherein
the manipulation determination unit further determines a manipulation corresponding to a motion of the living body based on required conditions that the contact action or the non-contact action is performed in a state where the whole or part of the position or area is placed on a side of the boundary plane or boundary line on the computer space after passing through the boundary plane or boundary line.

8. The manipulation determination apparatus according to claim 3, wherein
the manipulation determination unit further determines a manipulation corresponding to a motion of the living body based on required conditions that the contact action or the non-contact action is performed in a state where the whole or part of the position or area is crossing the boundary plane or boundary line on the computer space.

9. The manipulation determination apparatus according to claim 3, wherein
the manipulation determination unit further determines a manipulation corresponding to a motion of the living body based on required conditions that the contact action or the non-contact action is performed in a state where the whole or part of the position or area is placed inside a boundary defined by the boundary plane or boundary line on the computer space.

10. The manipulation determination apparatus according to claim 9, wherein
the manipulation determination unit further determines a manipulation corresponding to a motion of the living body based on required conditions that the living body moves toward outside of the boundary after performing the contact action or the non-contact action inside the boundary.

11. The manipulation determination apparatus according to claim 3, wherein
the manipulation determination unit further determines a manipulation corresponding to a motion of the living body based on required conditions that a contact state established by the contact action or a non-contact state established by the non-contact action is continued while the whole or part of the position or area is passing through the boundary plane or boundary line on the computer space.

12. The manipulation determination apparatus according to claim 3, wherein
the manipulation determination unit further determines a manipulation corresponding to a motion of the living body based on required conditions that a non-contact state is established while the whole or part of the position or area is moving from one side to the other side through the boundary plane or boundary line on the computer space, and a contact state is established while the whole or part of the position or area is moving back from the other side to the one side.

13. The manipulation determination apparatus according to claim 3, wherein
the whole or part of the boundary plane or boundary line on the computer space is a boundary plane or boundary line recognizable by the user in a real space.

14. The manipulation determination apparatus according to claim 13, wherein
the whole or part of the boundary plane or boundary line on the computer space is a plane or line displayed by a display unit.

15. The manipulation determination apparatus according to claim 13, wherein
the whole or part of the boundary plane or boundary line on the computer space is a line of a display frame of a display unit.

16. The manipulation determination apparatus according to claim 3, wherein
the allocation unit allocates the position or area onto the computer space corresponding to any of a motion of the head, a motion of an eyeball, a motion of a foot or leg, a motion of an arm, a motion of a hand or finger, and a motion of an eyeball of the user.

17. The manipulation determination apparatus according to claim 16, wherein
the allocation unit allocates a corresponding point or linear area onto the computer space depending on a direction of a line of sight based on a state of the eyeball, and/or
the allocation unit allocates a corresponding point, linear area, planar area, or three dimensional area onto the computer space based on a position or a joint bending angle of any of the head, mouth, feet, legs, arms, hands, and fingers.

18. The manipulation determination apparatus according to claim 3, wherein
the position or area allocated on the computer space by the allocation unit is displayed by a display unit.

19. The manipulation determination apparatus according to claim 3, wherein
while a contact state established by the contact action or a non-contact state established by the non-contact action is continued, the manipulation determination unit performs control not to release a target of a manipulation determination corresponding to the position or area at a start time of the contact action or the non-contact action.

20. The manipulation determination apparatus according to claim 19, wherein
the manipulation determination unit performs control not to release the target of the manipulation determination by:
(1) moving a whole or part of a display element in conjunction with a motion of the living body;
(2) storing, as a log, the position or area on the computer space at the start time of the contact action or the non-contact action;
(3) nullifying a movement of the position or area in a direction which renders the target of the manipulation determination released; and/or
(4) continuing holding the target of the manipulation determination at the start time of the contact action or the non-contact action.

21. The manipulation determination apparatus according to claim 3, wherein
the manipulation is any of a menu display manipulation or hide manipulation for a display unit, a display screen display manipulation or hide manipulation, a selectable element selection manipulation or non-selection manipulation, a display screen luminance-up manipulation or luminance-down manipulation, a sound output unit volume-up manipulation or volume-down manipulation, a mute manipulation or mute-cancel manipulation, or any of a turn-on manipulation, a turn-off manipulation, an open/close manipulation, and a setting manipulation for a parameter such as a setting temperature of an apparatus controllable by the computer.

22. The manipulation determination apparatus according to claim 3, wherein
the living body recognition unit detects a change between a contact state and a non-contact state of parts of the living body by detecting a change in an electrostatic energy of the user.

23. A manipulation determination method comprising:
a living body recognition step of recognizing a state of a living body of a user;
an allocation step of allocating a first area onto a computer space such that the first area moves in conjunction with the recognized state of the living body;
a change step of changing a motion of the first area in conjunction with the living body so as to make it harder for the first area to move through a second area allocated on the computer space; and
a manipulation determination step of determining that a manipulation corresponding to the second area is done when the first area and the second area come to have a predetermined relation.

24. A manipulation determination method comprising:
a living body recognition step of recognizing a state of a living body of a user;
an allocation unit of allocating a first area onto a computer space such that the first area moves in conjunction with the recognized state of the living body;
a change step of moving a second area allocated on the computer space such that the second area keeps away from the coming first area; and
a manipulation determination step of determining that a manipulation corresponding to the second area is done when the first area and the second area come to have a predetermined relation.

25. A manipulation determination method comprising:
a living body recognition step of recognizing a state of a living body of a user;
an allocation step of allocating a position or area onto a computer space such that the position or area moves in conjunction with the recognized state of the living body; and
a manipulation determination step of determining a manipulation corresponding to a motion of the living body based on required conditions that a whole or part of the position or area passes through a boundary plane or boundary line on the computer space, and that parts of the living body perform a contact action or a non-contact action.

26. A program causing a computer to execute:
a living body recognition step of recognizing a state of a living body of a user;
an allocation step of allocating a first area onto a computer space such that the first area moves in conjunction with the recognized state of the living body;
a change step of changing a motion of the first area in conjunction with the living body so as to make it harder for the first area to move through a second area allocated on the computer space; and
a manipulation determination step of determining that a manipulation corresponding to the second area is done when the first area and the second area come to have a predetermined relation.

27. A program causing a computer to execute:
a living body recognition step of recognizing a state of a living body of a user;
an allocation unit of allocating a first area onto a computer space such that the first area moves in conjunction with the recognized state of the living body;
a change step of moving a second area allocated on the computer space such that the second area keeps away from the coming first area; and
a manipulation determination step of determining that a manipulation corresponding to the second area is done when the first area and the second area come to have a predetermined relation.

28. A program causing a computer to execute:
a living body recognition step of recognizing a state of a living body of a user;
an allocation step of allocating a position or area onto a computer space such that the position or area moves in conjunction with the recognized state of the living body; and
a manipulation determination step of determining a manipulation corresponding to a motion of the living body based on required conditions that a whole or part of the position or area passes through a boundary plane or boundary line on the computer space, and that parts of the living body perform a contact action or a non-contact action.
